(19) United States
(12) Patent Application Publication
(10) Pub. No.: US 2022/0164595 A1
(43) Pub. Date: May 26, 2022

(54) METHOD, ELECTRONIC DEVICE AND STORAGE MEDIUM FOR VEHICLE LOCALIZATION

(71) Applicant: Beijing Baidu Netcom Science and Technology Co., Ltd., Beijing (CN)

(72) Inventors: Yao ZHOU, Beijing (CN); Guowei WAN, Beijing (CN); Shenhua HOU, Beijing (CN); Shiyu SONG, Beijing (CN)

(21) Appl. No.: 17/104,989

(22) Filed: Nov. 25, 2020

(51) Int. Cl. G06K 9/62; G06K 9/00

(52) U.S. Cl. CPC G06K 9/6214; G06K 9/6215; G06K 9/627; G06K 9/6256; G06K 9/00791

(57) ABSTRACT

The present disclosure provides a method, an apparatus, an electronic device and a storage medium for vehicle localization, which relates to the technical fields of autonomous driving, electronic map, deep learning, image processing, and the like. In the method, a computing device obtains an image descriptor map corresponding to a captured image of an external environment of a vehicle and a predicted pose of the vehicle when the captured image is captured; obtains a set of reference descriptors and a set of spatial coordinates corresponding to a set of keypoints of a reference image of the external environment; determines a plurality of sets of image descriptors corresponding to the set of spatial coordinates when the vehicle is in a plurality of candidate poses, respectively; determines a plurality of similarities between the plurality of sets of image descriptors and the set of reference descriptors; and updates the predicted pose based on the plurality of candidate poses and the plurality of similarities. Embodiments of the present disclosure can improve localization accuracy and robustness of the vehicle visual localization algorithm.

### BACKGROUND

### Technical Field

The present disclosure generally relates to the fields of computer technology and data processing technology, and also relates to the technical fields of autonomous driving, electronic map, deep learning, image processing, and the like.

### Description of the Related Art

Localization is a fundamental task in a self-driving system of a vehicle, and a localization model or localization system is a basic module in the self-driving system. Precise localization of a vehicle is not only an input required by a path planning module in the self-driving system, but can also be applied to simplify a scene interpretation and classification algorithm of an environment perception module. To exploit high definition maps (also referred to as HD maps) as priors for robust environment perception and safe motion planning, the localization system of a vehicle is typically required to reach centimeter-level accuracy.

### BRIEF SUMMARY

The present disclosure provides a technical solution for vehicle localization, more specifically a method for vehicle localization, an apparatus for vehicle localization, an electronic device and a computer readable storage medium.

According to a first aspect of the present disclosure, there is provided a method for vehicle localization. The method comprises: obtaining an image descriptor map corresponding to a captured image of an external environment of a vehicle and a predicted pose of the vehicle when the captured image is captured, the image descriptor map comprising descriptors of points in the captured image. The method also comprises: obtaining a set of reference descriptors and a set of spatial coordinates corresponding to a set of keypoints in a reference image of the external environment, the reference image being pre-captured by a capturing device. The method also comprises: determining a plurality of sets of image descriptors corresponding to the set of spatial coordinates when the vehicle is in a plurality of candidate poses, respectively, the plurality of sets of image descriptors belonging to the image descriptor map, the plurality of candidate poses being obtained by offsetting the predicted pose. The method also comprises: determining a plurality of similarities between the plurality of sets of image descriptors and the set of reference descriptors. The method further comprises: updating the predicted pose based on the plurality of candidate poses and the plurality of similarities corresponding to the plurality of candidate poses.

According to a second aspect of the present disclosure, there is provided an electronic device. The electronic device comprises at least one processor and a memory communicatively connected to the at least one processor. The memory stores instructions executable by the at least one processor, and the instructions when executed by the at least one processor cause the at least one processor to: obtain an image descriptor map corresponding to a captured image of an external environment of a vehicle and a predicted pose of the vehicle when the captured image is captured, the image descriptor map comprising descriptors of points in the captured image. The instructions when executed by the at least one processor also cause the at least one processor to: obtain a set of reference descriptors and a set of spatial coordinates corresponding to a set of keypoints in a reference image of the external environment, the reference image being pre-captured by a capturing device. The instructions when executed by the at least one processor also cause the at least one processor to: determine a plurality of sets of image descriptors corresponding to the set of spatial coordinates when the vehicle is in a plurality of candidate poses, respectively, the plurality of sets of image descriptors belonging to the image descriptor map, the plurality of candidate poses being obtained by offsetting the predicted pose. The instructions when executed by the at least one processor also cause the at least one processor to: determine a plurality of similarities between the plurality of sets of image descriptors and the set of reference descriptors. The instructions when executed by the at least one processor further cause the at least one processor to: update the predicted pose based on the plurality of candidate poses and the plurality of similarities corresponding to the plurality of candidate poses.

According to a third aspect of the present disclosure, there is provided a non-transitory computer readable storage medium storing computer instructions. The computer instructions cause a computer to perform the method of the first aspect of the present disclosure.

Embodiments of the present disclosure can improve localization accuracy and robustness of a vehicle visual localization algorithm, thereby boosting performance of a vehicle localization system.

It should be appreciated that this Summary is not intended to identify key features or essential features of the embodiments of the present disclosure, nor is it intended to be used to limit the scope of the disclosure. Other features of the present disclosure will be made apparent by the following description.

### BRIEF DESCRIPTION OF THE SEVERAL VIEWS OF THE DRAWINGS

Through reading the following detailed description with reference to the accompanying drawings, the above and other objectives, features, and advantages of embodiments of the present disclosure will become more comprehensible. Several embodiments of the present disclosure will be illustrated in the drawings by way of example, without limitation. Therefore, it should be appreciated that the drawings are provided for better understanding of the technical solution of the present application, without constituting limitations to the present application.

FIG. 1 illustrates a schematic diagram of an example environment in which some embodiments of the present disclosure can be implemented.

FIG. 2 illustrates a flowchart of an example process for vehicle localization according to embodiments of the present disclosure.

FIG. 3 illustrates an example of obtaining an image descriptor map by inputting a captured image into a feature extraction model, according to embodiments of the present disclosure.

FIG. 4 illustrates an example of obtaining a reference descriptor map by inputting a reference image into a feature extraction model, according to embodiments of the present disclosure.

FIG. 5 illustrates an example of a set of keypoints in a reference image as well as a set of reference descriptors and a set of spatial coordinates associated with the set of keypoints, according to embodiments of the present disclosure.

FIG. 6 illustrates a schematic diagram of a predicted pose and a plurality of candidate poses represented in the form of a cube according to embodiments of the present disclosure.

FIG. 7 illustrates a schematic diagram of determining a first set of image descriptors by projecting a set of spatial coordinates onto a captured image on the assumption that a vehicle is in a first candidate pose, according to embodiments of the present disclosure.

FIG. 8 illustrates a schematic diagram of obtaining an updated predicted pose by inputting a set of spatial coordinates, a set of reference descriptors, a predicted pose and an image descriptor map into a pose updating module, according to embodiments of the present disclosure.

FIG. 9 illustrates an example structure of a feature extraction model according to embodiments of the present disclosure.

FIG. 10 illustrates a flowchart of an example process for obtaining a set of reference descriptors and a set of spatial coordinates corresponding to a set of keypoints, according to embodiments of the present disclosure.

FIG. 11 illustrates a schematic diagram of capturing, by a capturing vehicle, a set of reference images of an external environment and generating a localization map, according to embodiments of the present disclosure.

FIG. 12 illustrates an example modularized operation process for generating a localization map according to embodiments of the present disclosure.

FIG. 13 illustrates a flowchart of an example process for determining a plurality of sets of image descriptors according to embodiments of the present disclosure.

FIG. 14 illustrates an example structure of a pose updating model according to embodiments of the present disclosure.

FIG. 15 illustrates an example modularized operation process for generating an updated predicted pose using a feature extraction model and a pose updating model, according to embodiments of the present disclosure.

FIG. 16 illustrates a block diagram of an example apparatus for vehicle localization according to embodiments of the present disclosure.

FIG. 17 illustrates a block diagram of an example device that can be used to implement embodiments of the present disclosure.

Throughout the drawings, the same or similar reference signs refer to the same or similar elements.

### DETAILED DESCRIPTION

Example embodiments of the present application will now be described in connection with the drawings in the following, including various details of those embodiments of the present application for better understanding, which should be considered as being provided exemplarily. Thus, it would be appreciated by those skilled in the art that various changes and modifications to the embodiments described herein can be made, without departing from the scope and spirit of the present application. Moreover, description of well-known functionalities and structures will be omitted in the following description for clarity and brevity.

As aforementioned, localization is a fundamental task in a self-driving system of a vehicle. To exploit high definition maps as priors for robust environment perception and safe motion planning, the localization system of an unmanned vehicle may be required to reach centimeter-level accuracy. Despite many decades of research, building a long-term, precise and reliable localization system using low-cost sensors, such as automotive and consumer-grade global positioning system (GPS)/inertial measurement unit (IMU) and cameras, is still an open-ended and challenging problem.

Traditional solutions for visual localization of a vehicle are mainly divided into two categories. One category of traditional solutions accomplishes vehicle localization by matching local keypoints in a high definition map with corresponding keypoints in a real-time (also referred to as “online”) image captured by the vehicle. Generally speaking, this category of traditional solutions leverages a conventional approach or machine learning-based approach for extracting keypoints from a high definition map to build a sparse keypoint map. When performing online localization of a vehicle, a pose of the vehicle is computed by determining a “three-dimensional and two-dimensional (3D-2D)” correspondence relation between keypoints in the sparse keypoint map and keypoints in the online image captured by the vehicle.

However, compared to the Light Detection and Ranging (LiDAR), cameras of a vehicle are passive sensors, meaning that they are more susceptible to changes in the appearance of an object, which may be caused by varying light conditions or changes in viewpoints. Accordingly, in the category of traditional solutions, handcrafted point features suffer from unreliable feature matching under large lighting or viewpoint changes, leading to localization failure of the vehicle eventually. Even when using most recent deep features, local 3D-2D matching is prone to fail under strong visual changes in practice due to the lack of repeatability in the keypoint detector, thereby impacting the final vehicle localization result. In addition, repeated structures may exist in some natural environments that a vehicle may encounter, and such repeated structures probably lead to failure in achieving a good effect in one-to-one keypoint matching.

The other category of traditional solutions achieves vehicle localization using human-made objects, where specific appearances and semantic meanings in an environment or scene are encoded, such as lane markings, road signs, road curbs, poles, and the like. Those features are typically considered relatively stable and can be easily recognized as they are built by humans for specific purposes and also used by human drivers to aid their driving behavior. Based on such concepts, in this category of traditional solutions, various human-made elements, such as lane markings, poles, and the like, are used for localization. Specifically, types of the artificial elements for localization may be predetermined by humans and stored in a high definition map. When performing online localization of a vehicle, the artificial elements in the high definition map may be compared with the artificial elements detected by the vehicle in real time to obtain a pose of the vehicle.

Nonetheless, such category of traditional solutions is only adaptive for environments with rich human-made features but easily fail in scenarios that lack the human-made features, for example, road sections with worn-out markings under poor maintenance, rural streets with no lane markings or other open spaces without clear signs. In addition, these carefully selected semantic signs or markings typically only cover a small area in an image. This leads to an obvious design paradox in such category of traditional solutions, namely, it suffers from the usual absence of distinctive human-made features for vehicle localization, but at the same time, it deliberately abandons rich and important information in an image by solely relying on human-made features. Moreover, since high definition map elements for vehicle localization are defined manually, considerable manual labor for identification and marking are required. Further, it is hard to define some elements (for example, a curved trunk at a roadside) for vehicle localization. Furthermore, labor-intensive adjustments are required for matching high definition map elements for vehicle localization with online elements.

In view of the foregoing research and analysis, embodiments of the present disclosure propose a technical solution for vehicle localization, and specifically provide a method, electronic device and computer storage medium for vehicle localization to at least partly solve the above technical problems and other potential technical problems in the traditional solutions.

As used herein, vehicle localization refers to determining a position and a posture of a vehicle, which are collectively referred to as a pose. In the technical solution for vehicle localization provided by the present disclosure, a computing device of a vehicle (or another computing device) may obtain an image (also referred to as a captured image herein) of an external environment external to the vehicle captured by an imaging device of the vehicle, and a predicted pose when the vehicle is capturing the image. The accuracy of the predicted pose may be less than a predetermined threshold and thus cannot be applied to applications (for example, autonomous driving) requiring high accuracy localization. Then, based on the captured image and a reference image of the external environment, the computing device may update the predicted pose of the vehicle to ultimately obtain a predicted pose with accuracy greater than the predetermined threshold, for use in applications requiring high accuracy localization.

In order to update the predicted pose of the vehicle, on one hand, the computing device may process the captured image of the external environment to obtain an image descriptor map of the captured image. In the context of the present disclosure, a descriptor map of an image may refer to a map formed by descriptors corresponding to respective image points in the image. In other words, in a position corresponding to a certain image point (for example, a pixel) of the image, a descriptor of the image point is recorded in the descriptor map.

On the other hand, the computing device may obtain a reference image of the external environment captured by a capturing device (for example, a high definition map capturing a vehicle or the like). During the pre-capturing of the external environment performed by the capturing device, spatial coordinate information associated with the reference image may also be collected. As such, the computing device may obtain spatial coordinates corresponding to image points in the reference image, such as, three-dimensional spatial coordinates. In this event, the computing device may select a set of keypoints for aiding vehicle localization from all image points in the reference image, and may further obtain a set of reference descriptors and a set of spatial coordinates corresponding to the set of keypoints. The set of reference descriptors includes descriptors corresponding to respective keypoints in the set of keypoints, and the set of spatial coordinates includes spatial coordinates corresponding to respective keypoints in the set of keypoints.

As indicated, the predicted pose of the vehicle obtained by the computing device is not a real pose of the vehicle, but approximates the real pose of the vehicle to a certain extent. In other words, the real pose of the vehicle may be considered as “adjacent to” the predicted pose of the vehicle. In light of this idea, in embodiments of the present disclosure, the computing device may obtain a plurality of “candidate poses” for the real pose of the vehicle by offsetting the predicted pose. Then, the computing device can determine the updated predicted pose of the vehicle based on the plurality of candidate poses.

To this end, for a certain candidate pose of the plurality of candidate poses, the computing device may assume that it is the real pose of the vehicle. Under this assumption, in the image descriptor map of the captured image, the computing device may determine a set of image descriptors corresponding to the set of spatial coordinates. Since there are a plurality of candidate poses, the computing device can determine a plurality of sets of image descriptors respectively corresponding to the plurality of candidate poses in the same manner. Thereafter, the computing device may determine a plurality of similarities between the plurality of sets of image descriptors and the set of reference descriptors, and update the predicted pose based on the plurality of candidate poses and the respective plurality of similarities.

The technical solution of the present disclosure provides a novel visual localization framework, and for example, can be used for autonomous driving of a vehicle, which does not rely on artificial elements in a map (for example, a high definition map) for localization or selection of local keypoints in the map, thereby avoiding inherent deficiencies and problems in the two above-mentioned categories of traditional solutions. In addition, the technical solution of the present disclosure can significantly improve the localization accuracy and robustness of vehicle localization, for example, yielding centimeter level precision under various challenging lighting conditions. Some example embodiments of the present disclosure will be described below with reference to the drawings.

### Example Environment

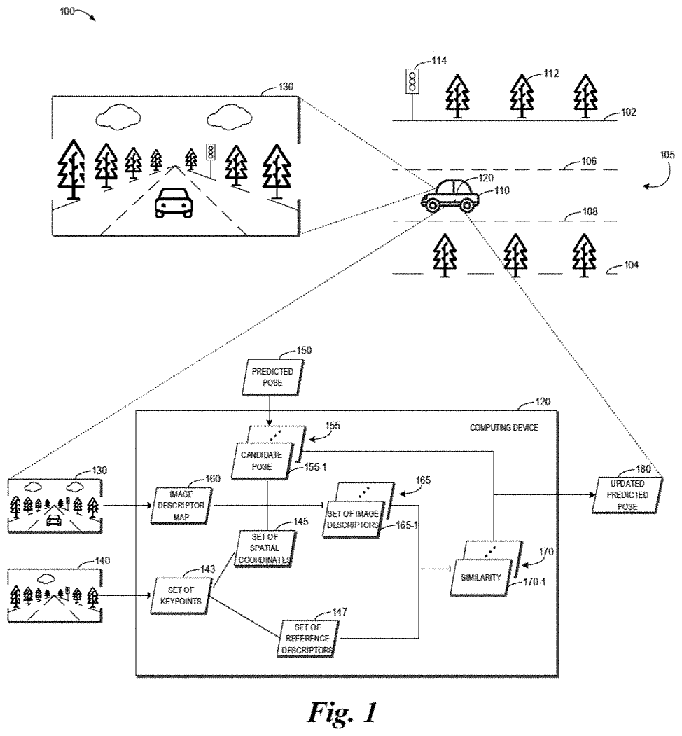

FIG. 1 illustrates a schematic diagram of an example environment 100 in which some embodiments of the present disclosure can be implemented. As shown in FIG. 1, the example environment 100 may include a vehicle 100 and an external environment 105 with respect to the vehicle 110. For example, the vehicle 110 may be traveling on a road defined by road boundary lines 102 and 104. In some embodiments, the vehicle 110 may be in a parked state rather than in a traveling state, for example, due to an indication of a traffic light or a traffic jam. More generally, the embodiments of the present disclosure are not limited to a particular movement state of the vehicle 110, but are equally applicable to the vehicle 110 in any movement state. In some embodiments, the vehicle 110 may be a driverless vehicle, also referred to as an unmanned vehicle. In some other embodiments, the vehicle 110 may be a manned vehicle which has an autonomous driving function to assist the driver in driving. In other embodiments, the vehicle 110 may be an ordinary vehicle without the autonomous driving function.

As shown, the example road in FIG. 1 is divided by lane markings 106 and 108 into three lanes, and the vehicle 110 is depicted as traveling in the middle lane. However, it should be appreciated that such depiction is merely an example. Embodiments of the present disclosure are not limited to a particular position of the vehicle 110, but are equally applicable to any possible position of the vehicle 110. In the example of FIG. 1, vegetation is provided outside the road boundary lines 102 and 104, for example, trees 112 and the like. Moreover, traffic support facilities, for example a traffic light 114 and the like, are also provided outside the road boundary line 102. It should be appreciated that the trees 112 and the traffic light 114 as depicted in FIG. 1 are merely an example, without suggesting any limitation to the scope of the present disclosure. Embodiments of the present disclosure are equally applicable to a road environment including any object or facility, and are also equally applicable to a non-road environment.

In the context of the present disclosure, the external environment 105 of the vehicle 110 may include or contain all objects, targets or elements outside the vehicle 110. For example, the external environment 105 may include the road boundary lines 102 and 104, the lane markings 106 and 108, the trees 112, the traffic light 114, and the like, as shown in FIG. 1. As another example, the external environment 105 may include other transportation means, pedestrians and other objects in traffic around the vehicle 110, such as, other vehicles traveling on the road and the like. As a further example, the external environment 105 can also include the sun, the moon, stars, clouds, aircrafts, flying animals in the sky, and the like.

In some embodiments, the vehicle 110 may capture a captured image 130 of the external environment 105 via an imaging device (not shown) and provide it to a computing device 120 of the vehicle 110. It should be noted that the imaging device as used herein may be an imaging device fixedly mounted on the vehicle 110, an imaging device handheld by a passenger within the vehicle 110, an imaging device outside the vehicle 110, or the like. Embodiments of the present disclosure do not restrict the specific positional relation between the imaging device and the vehicle 110. For convenience of description, the imaging device for capturing the external environment 105 of the vehicle 110 will be referred to as the imaging device of the vehicle 110 in the following. However, it should be appreciated that embodiments of the present disclosure are equally applicable to a situation where the imaging device is not fixedly mounted on the vehicle 110.

In general, the imaging device of the vehicle 110 may be any device having an imaging function. Such imaging device includes, but is not limited to, a camera, a video camera, a camcorder, a driving recorder, a surveillance probe, a movable device having an image capturing or video recording function, and the like. For instance, in the example of FIG. 1, the captured image 130 captured by the imaging device of the vehicle 110 presents road boundaries, lane markings, trees, a traffic light, a vehicle in front of the vehicle 110, clouds in the sky, and other objects. It should be understood that various objects presented in the captured image 130 as depicted in FIG. 1 are merely an example, without suggesting any limitation to the scope of the present disclosure. Embodiments of the present disclosure are equally applicable to a situation where the captured image 130 presents any possible objects.

In addition to obtaining the captured image 130, the computer device 120 may obtain a predicted pose 150 of the vehicle 110 when capturing the captured image 130. As used herein, the pose of the vehicle 110 may refer to a position where the vehicle 110 is located and a posture that the vehicle 110 has. In some embodiments, the pose of the vehicle 110 may be represented by six degrees of freedom (DoF). For example, the position of the vehicle 110 can be represented by a horizontal coordinate (x coordinate), a longitudinal coordinate (y coordinate) and a vertical coordinate (z coordinate) of the vehicle 110 in a predetermined reference coordinate system, and the posture of the vehicle 110 may be represented by a pitch angle relative to a horizontal axis (x axis), a yaw angle relative to a longitudinal axis (y axis) and a roll angle relative to a vertical axis (z axis). It should be appreciated that the pose of the vehicle 110 represented by a horizontal coordinate, a longitudinal coordinate and a vertical coordinate, a pitch angle, a yaw angle and a roll angle is provided only as an example. Embodiments of the present disclosure are equally applicable to a situation where the pose of the vehicle 110 is expressed or described in any other manner. For example, the position of the vehicle 110 can also be represented by latitude, longitude and altitude coordinates, and the pitch angle, the yaw angle and the roll angle may be described in other equivalent manners.

In some circumstances, the measurement of some of the six degrees of freedom may be implemented through some known, well-developed approaches. For example, the vertical coordinate, the pitch angle and the roll angle of the vehicle 110 on the road may be estimated or determined in a simpler way in practice. For example, a customer-grade inertial measurement unit is eligible to precisely estimate the roll angle and the pitch angle, due to non-negligible gravity. As another example, after the vehicle 110 is successfully located horizontally, the altitude of the vehicle 110 may be estimated or determined by reading a Digital Elevation Model (DEM) map. Therefore, in some implementations, embodiments of the present disclosure may focus only on the determination of three degrees of freedom (namely, the horizontal axis, the longitudinal axis and the yaw angle axis) in the pose of the vehicle 110. However, it should be appreciated that embodiments of the present disclosure may be equally applicable to the determination of all the six degrees of freedom in the pose of the vehicle 110, or may be equally applicable to the determination of more or fewer degrees of freedom in the pose of the vehicle 110.

In the context of the present disclosure, the pose of the vehicle 110 and the pose of the imaging device of the vehicle 110 may be regarded as having a fixed conversion relation, that is, the two can be deduced from each other based on the conversion relation. The specific conversion relation may be dependent on how the imaging device is provided on or in the vehicle 110. As a result, although the pose of the imaging device determines in which direction and angle the captured image 130 is captured and impacts the image features in the captured image 130, the captured image 130 may be used to determine the pose of the vehicle 110 due to the fixed conversion relation. Accordingly, in the context of the present disclosure, the pose of the vehicle 110 and the pose of the imaging device are not substantially distinguished from each other unless otherwise indicated, and the two are considered to be consistent in the sense of the embodiments of the present disclosure. For example, when the vehicle 110 is in different poses, the objects presented in the captured image 130 of the external environment 105 captured by the vehicle 110 are varied. For example, the positions and angles of the respective objects in the captured image 130 may be changed. As such, the image features of the captured image 130 may embody the pose of the vehicle 110.

In some embodiments, the accuracy of the predicted pose 150 of the vehicle 110 obtained by the computing device 120 may be less than a predetermined threshold and thus cannot be used in applications requiring high localization accuracy, for example, autonomous driving of the vehicle 110, and the like. Therefore, the computing device 120 may need to update the predicted pose 150, so as to obtain the updated predicted pose 180 with accuracy greater than the predetermined threshold for use in applications requiring high localization accuracy, for example, autonomous driving of the vehicle 110, and the like. In some embodiments, the predicted pose 150 of the vehicle 110 may be determined roughly in other less accurate localization manners. Then, the rough predicted pose may be updated to an accurate predicted pose. In other embodiments, the predicted pose 150 of the vehicle 110 may be obtained through the technical solution of the present disclosure. In other words, the technical solution for vehicle localization of the present disclosure can be used iteratively to update the predicted pose of the vehicle 110.

In order to update the predicted pose 150, the computing device 120 may obtain a reference image 140 of the external environment 105, in addition to obtaining the captured image 130. The reference image 140 of the external environment 105 may be pre-captured by a capturing device. For example, in some embodiments, the capturing device may be a capturing vehicle for generating a high definition map. In other embodiments, the capturing device may be any other surveying and mapping device for collecting data for a road environment. It should be noted that when the capturing device is capturing the reference image 140 of the external environment 105, other measurement information associated with the reference image 140 may be collected as well, for example, spatial coordinate information corresponding to image points in the reference image 140.

In the context of the present disclosure, a high definition map typically refers to an electronic map having high accuracy data. For example, the high accuracy used herein, on one hand, means that the high definition electronic map has high absolute coordinate accuracy. The absolute coordinate accuracy refers to the accuracy of a certain target on the map relative to a corresponding real object in the external world. On the other hand, road traffic information elements contained in the high definition map are more abundant and finer. As another example, the absolute accuracy of the high definition map is generally at the sub-meter level, namely, it has accuracy within 1 meter, and the relative accuracy in the horizontal direction (for example, the relative position accuracy between lanes or between a lane and a lane marking) is often much higher. In addition, in some embodiments, the high definition map includes not only high accuracy coordinates but also a precise road shape, a slope and curvature of each lane, heading, elevation, and roll data.

In some embodiments, the high definition map can depict not only a road but also a number of lanes on the road, so as to truly reflect the actual road condition.

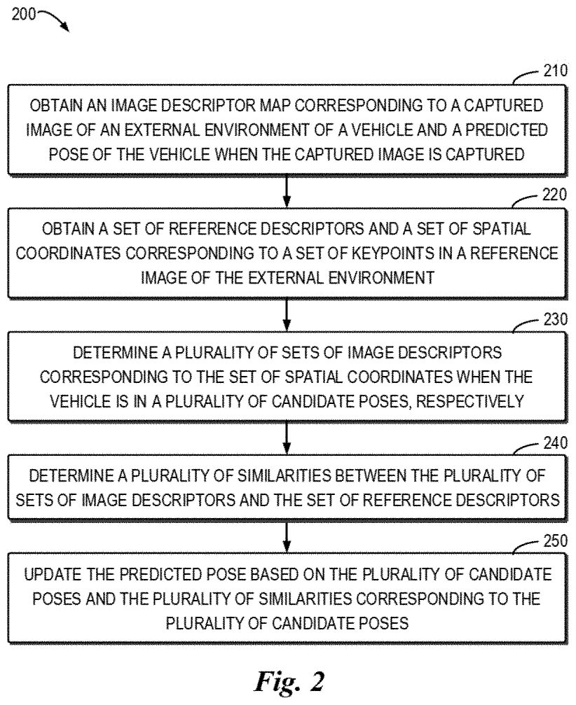

As shown in FIG. 1, in some embodiments, by processing the captured image 130, the reference image 140 and the predicted pose 150, the computing device 120 may update the predicted pose 150 to obtain an updated predicted pose 180. For example, the accuracy of the updated predicted pose 180 may be greater than the predetermined threshold such that it can be used in an application having a higher requirement on the localization accuracy of the vehicle 110, for example, autonomous driving, and the like. Reference will be made to FIG. 2 hereinafter to describe in detail an example process of obtaining the updated predicted pose 180 by the computing device 120.

It should be noted that, although described with the example environment 100 including the vehicle 110 in FIG. 1, embodiments of the present disclosure are not limited to vehicle localization. To be more general, embodiments of the present disclosure may be equally applied to localize any device or tool, such as means of transportation, an unmanned aerial vehicle, an industrial robot, and the like. As used herein, the means of transportation refers to any movable tool that can carry people and/or objects. For example, the vehicle 110 in FIG. 1 may be a motorized or non-motorized vehicle, including but not limited to, a car, a sedan, a truck, a bus, an electric vehicle, a motorcycle, a bicycle, and the like. However, it should be appreciated that the vehicle 110 is only an example of a means of transportation. Embodiments of the present disclosure are equally applied to any other means of transportation other than an automobile, for example, a ship, a train, an airplane, and the like.

In some embodiments, the computing device 120 may include any device that can implement a computing function and/or a control function, which may be any type of fixed computing device, movable computing device or portable computing device, including but not limited to, a dedicated computer, a general-purpose computer, a desktop computer, a laptop computer, a notebook computer, a netbook computer, a tablet computer, a multimedia computer, a mobile phone, a general-purpose processor, a microprocessor, a microcontroller, or a state machine. The computing device 120 may be implemented as an individual computing device or a combination of computing devices, for example, a combination of a Digital Signal Processor (DSP) and a microcontroller, a plurality of microprocessors, a combination of one or more microprocessors and a DSP core, or any other similar configurations.

It should be noted that, although the computing device 120 is depicted as being arranged inside the vehicle 110 in FIG. 1, this is only an example without suggesting any limitation to the scope of the present disclosure. In other embodiments, the computing device 120 may also be arranged in a position remote from the vehicle 110. For example, the computing device 120 may a cloud computing device. In this circumstance, the vehicle 110 may transmit data or information to be processed to the remote computing device 120 via a wireless or wired communication network. Having completed the processing of the data or the information, the computing device 120 may send a processing result, control command, or the like to the vehicle 110. Moreover, in the context of the present disclosure, the computing device 120 may also be referred to as an electronic device 120, and the two terms can be used interchangeably.

In addition, it should be appreciated that FIG. 1 only schematically shows objects, units, elements, or components related to embodiments of the present disclosure in the example environment 100. In practice, the example environment 100 may also include other objects, or units, elements, components and the like for other functions. Further, the specific number of objects, units, elements, or components as shown in FIG. 1 is merely an example, without suggesting any limitation to the scope of the present disclosure. In other embodiments, the example environment 100 may include any appropriate number of objects, units, elements, components, or the like. Therefore, instead of being confined to the specific scenario as depicted in FIG. 1, embodiments of the present disclosure are generally applicable to any technical environment requiring localization of an object (for example, a vehicle). References will be made to FIGS. 2-8 below to describe an example process for locating a vehicle of embodiments of the present disclosure.

### Example Process for Vehicle Localization

FIG. 2 illustrates a flowchart of an example process 200 for vehicle localization according to embodiments of the present disclosure. In some embodiments, the example process 200 may be implemented by a computing device 120 of the vehicle 110 in the example environment 100, for example, by a processor or processing unit of the computing device 120, or by various functional modules of the computing device 120. In other embodiments, the example process 200 may be implemented by a computing device independent of the example environment 100, or by other unit or module in the example environment 100. Through the example process 200, localization accuracy and robustness of visual localization of the vehicle 110 can be improved significantly. For ease of illustration, reference will be made to FIG. 1 to describe the example process 200.

As described above, prior to performing the example process 200, the computing device 120 may obtain a captured image 130 of the external environment 105 captured by an imaging device (not shown) of the vehicle 110. Then, at block 210 of the example process 200, the computing device 120 may obtain an image descriptor map 160 corresponding to the captured image 130. In some embodiments, the image descriptor map 160 may include descriptors of respective image points in the captured image 130. For example, in the image descriptor map 160, a position corresponding to an image point in the captured image 130 records a descriptor of the image point. In some embodiments, a descriptor of an image point is extracted from an image block where the image point is located (for example, an image block with a center at the image point), and the descriptor may be represented by a multidimensional vector. For example, descriptors of respective pixels in the captured image 130 may be represented using 8-dimensional vectors to form the image descriptor map 160. A pixel of the captured image 130 is only an example of an image point of the captured image 130. In other embodiments, an image point may also refer to an image unit larger or smaller than a pixel. In addition, it is only an example to represent a descriptor of an image point using an 8-dimensional vector, and embodiments of the present disclosure are equally applicable to a descriptor represented using a vector in any number of dimensions.

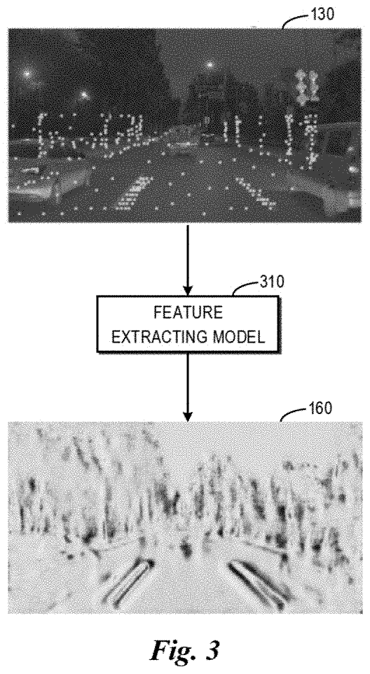

The computing device 120 may obtain the image descriptor map 160 corresponding to the captured image 130 in any appropriate manner. For example, for a certain image point in the captured image 130, the computing device 120 may extract a descriptor of the image point from an image block where the image point is located, according to a predetermined feature extraction algorithm. Likewise, the computing device 120 may extract a descriptor of each image point in the captured image 130 to obtain the image descriptor map 160. In other embodiments, the computing device 120 may input the captured image 130 into a trained machine learning model and then gain the image descriptor map 160 at the output of the machine learning model. For ease of description, the machine learning model for extracting a descriptor map from an image may also be referred to as a feature extraction model or a Local Feature Embedding (LFE) module as used herein. Since the feature extraction model is trained using training data, the image descriptor map 160 extracted by the trained feature extraction model can be more suitable for locating the vehicle 110. For example, the feature extraction model may be trained based on a difference between an estimated pose of the vehicle 110 obtained ultimately through the example process 200 and a real pose of the vehicle 110, such that the image descriptor map 160 generated using the trained feature extraction model can improve the localization accuracy of the vehicle 110. Reference will be made to FIG. 3 below to further describe such embodiments.

FIG. 3 illustrates an example of obtaining the image descriptor map 160 by inputting the captured image 130 into a feature extraction model 310, according to embodiments of the present disclosure. In some embodiments, the feature extraction model 310 may be trained and utilized by the computing device 120. In other embodiments, the feature extraction model 310 may be trained by an entity (for example, another computing device) other than the computing device 120, and then provided to the computing device 120 for use. In further embodiments, the feature extraction model 310 may be operated or implemented by other entities. In this event, the computing device 120 may provide the captured image 130 to an entity implementing the feature extraction model 310 and then receive the image descriptor map 160 of the captured image 130 from the entity.

In FIG. 3, in order to more intuitively and clearly display the captured image 130 and the image descriptor map 160, the captured image 130 is represented as an image captured when the vehicle 110 is traveling on a real road, and the image descriptor map 160 is an image descriptor map presented after visualization processing. As shown in FIG. 3, the captured image 130 may be input into the feature extraction model 310, and the feature extraction model 310 may in turn process the input captured image 130 to extract image features in the captured image 130 and thus generate the image descriptor map 160. Then, the feature extraction model 310 may output the generated image descriptor map 160. As a result, the feature extraction model 310 may be regarded as an image processing model.

As aforementioned, the feature extraction model 310 may be trained based on a difference between the estimated pose and the real pose of the vehicle 110. More specifically, the feature extraction model 310 may be trained based on a set of training images of the external environment 105 and a set of training descriptor maps obtained from a set of training images. The set of training descriptor maps may be used in the example process 200 to generate an updated predicted pose (namely, an estimated pose) of the vehicle 110 as determined ultimately, and the set of training descriptor maps therefore can be determined based on the difference between the estimated pose and the real pose of the vehicle 110. The feature extraction model 310 trained in this manner can improve the localization accuracy of the vehicle 110.

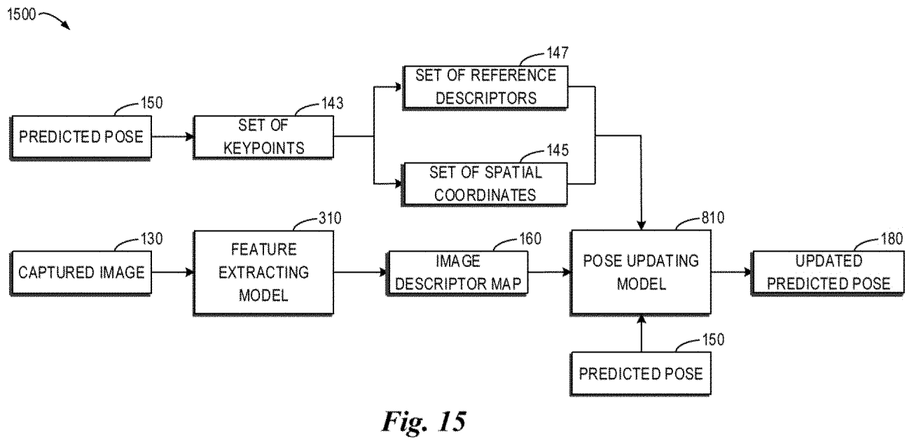

In some embodiments, since in the example process 200, the feature extraction model 310 may be used to process an image of the external environment 105 captured from the vehicle 110 or an image of the external environment 105 captured by a capturing device, the set of training images may be captured by the imaging device of the vehicle 110, pre-captured by a capturing device, or the combination of both. For example, in some embodiments, the feature extraction model 310 may be a part of the localization system for locating the vehicle 110, and the localization system may include machine learning models for other functions. In those embodiments, the computing device 120 may implement, based on the difference between the estimated pose of the vehicle 110 determined by the localization system and the real pose of the vehicle 110, an end-to-end training of the feature extraction model 310 together with other machine learning models. Such embodiments will be detailed hereinafter with reference to FIG. 15.

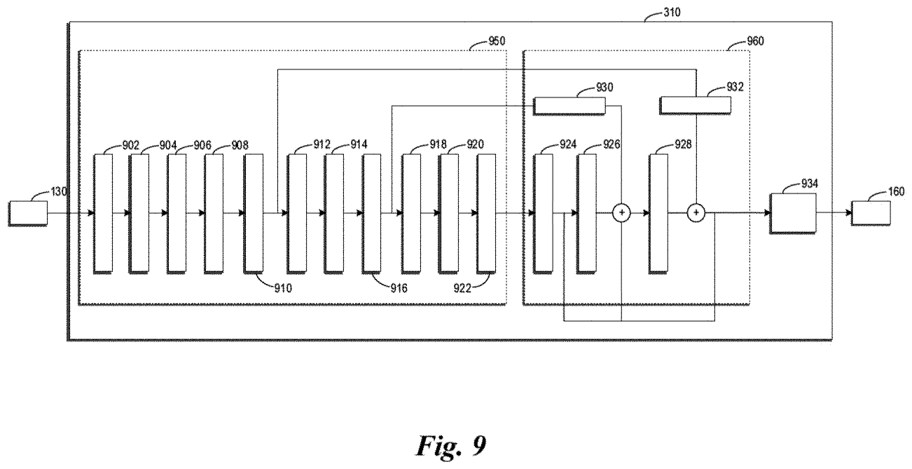

In general, the feature extraction model 310 may be implemented using a convolutional neural network, for example, a deep learning-based convolutional neural network of any appropriate architecture. In some embodiments, considering that the feature extraction model 310 is used for visually locating the vehicle 110, the feature extraction model 310 may be designed to extract good local feature descriptors from the image of the external environment 105, so as to achieve accurate and robust visual localization of the vehicle 110. More specifically, the descriptors extracted by the feature extraction model 310 from the image of the external environment 105 may have robustness. That is, despite appearance changes caused by varying lighting conditions, or changes in viewpoint, season or the like, feature matching can still be achieved to complete visual localization of the vehicle 110. To this end, in some embodiments, the feature extraction model 310 may be implemented using a convolutional neural network based on a feature pyramid network. Reference will be made to FIG. 9 hereinafter to describe those embodiments in detail.

Referring back to FIG. 2, at block 210, in addition to the image descriptor map 160 of the captured image 130, the computing device 120 may obtain a predicted pose 150 of the vehicle 110 when the captured image 130 is captured. As stated above, the predicted pose 150 obtained by the computing device 120 may be a pose with accuracy less than a predetermined threshold. For example, the predicted pose 150 may not be used in applications requiring high localization accuracy, such as autonomous driving of the vehicle 110 and the like. Consequently, the computing device 120 may update the predicted pose 150 based on the captured image 130, in order to obtain an updated predicted pose 180 with accuracy greater than the predetermined threshold for use in applications requiring high localization accuracy.

In some embodiments, the predicted pose 150 may be an updated predicted pose 150 obtained after the computing device 120 updated a predicted pose of the vehicle 110 previously using the example process 200. Then, the computing device 120 may use the example process 200 again to further update the predicted pose 150. In other words, the computing device 120 may iteratively use the example process 200 to update the predicted pose of the vehicle 110, so as to gradually approach the real pose of the vehicle 100 from the rough predicted pose of the vehicle 110 and thus obtain the more accurate predicted pose of the vehicle 110 with localization accuracy less than the predetermined threshold.

In other embodiments, the predicted pose 150 may also be obtained by the computing device 120 using other measurement means. For example, the computing device 120 may obtain an incremental motion estimation of the vehicle 110 from an IMU sensor and then accumulate it to a localization result obtained based on the preceding frame of the captured image 130, so as to estimate the predicted pose 150 when the vehicle 110 is capturing the captured image 130. As another example, at the initial stage of the example process 200, the computing device 120 may obtain the predicted pose 150 of the vehicle 110 using a GPS positioning technology (outdoors), other image retrieval technology or Wi-Fi fingerprint identification technology (indoors), and the like. In some other embodiments, the computing device 120 may obtain the predicted pose 150 of the vehicle 110 when capturing the captured image 130 in any other appropriate manner.

As described above with reference to FIG. 1, in addition to the captured image 130, the computing device 120 may gain a reference image 140 of the external environment 105 pre-captured by a capturing device, for use in feature matching with the captured image 130, so as to implement the localization of the vehicle 110. To this end, at block 220 of the example process 200, the computing device 120 may obtain a set of reference descriptors 147 and a set of spatial coordinates 145 corresponding to a set of keypoints 143 of the reference image 140. More specifically, at some time before the vehicle 110 captures the captured image 130 of the external environment 105 via an imaging device, the capturing device may capture the reference image 130 of the external environment 105. For example, the capturing device may capture the reference image 140 of the external environment 105 to produce a high definition map of the external environment 105. During the capturing, the capturing device (for example, a capturing vehicle) may travel in an area including the external environment 105 and capture a video or a set of images (including the reference image 140 of the external environment 105) of this area during traveling.

In the case that the capturing device pre-captures the set of reference images about the external environment 105 (for example, a video or a series of reference images), the computing device 120 may need to determine the reference image 140 corresponding to the captured image 130 from the set of reference images, namely, to look for the reference image 140 in the set of reference images. For example, the computing device 120 may directly compare the captured image 130 with each reference image in the set of reference images and then select a reference image closest to the captured image 130 in the set of reference images as the reference image 140. As another example, when capturing the set of reference images, the capturing device can record a pose of the capturing device when capturing each reference image. In this event, the computing device 120 may select, from the set of reference images, a reference image related to the capturing pose of the capturing device closest to the predicted pose 150 of the vehicle 110, as a reference image 140. It is provided only as an example that the computing device 120 selects the reference image closest to the captured image 130, or a reference image closest to the captured image 130 in capturing pose, as the reference image 140. In other embodiments, the computing device 120 may select a reference image relatively close to the captured image 130 in image per se or capturing pose, as a reference image 140. For example, the difference between the two is less than a predetermined threshold, and so on. More generally, the computing device 120 may obtain a reference image 140 corresponding to the captured image 130 in any other appropriate manner.

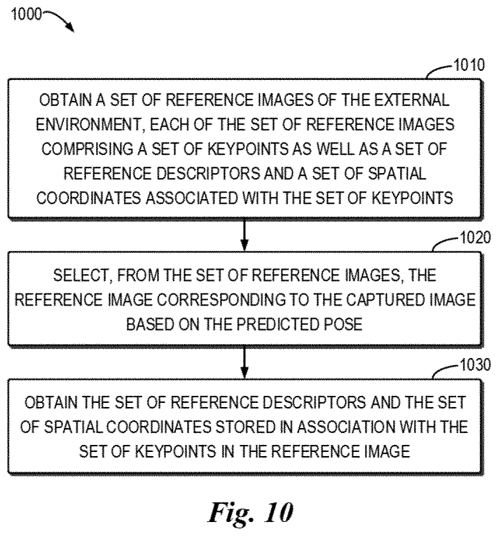

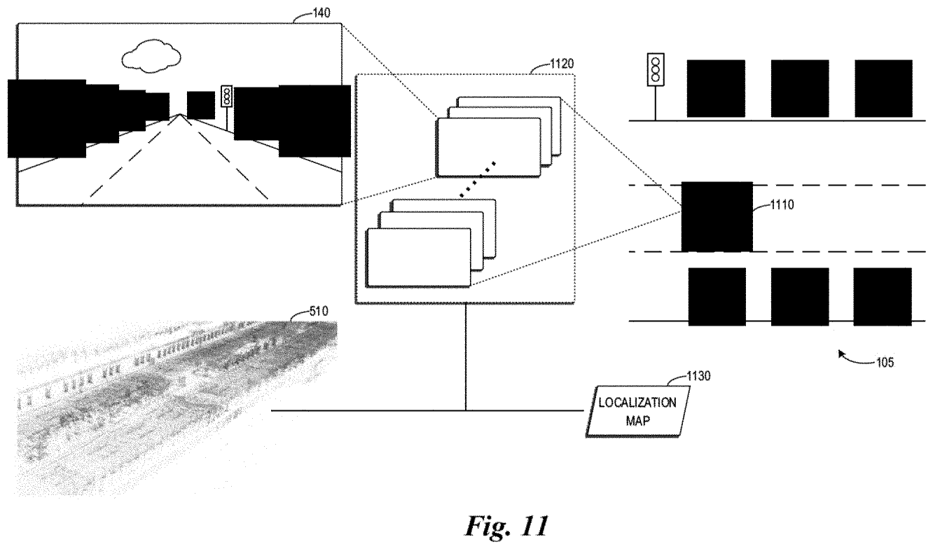

After acquiring the reference image 140 of the external environment 105, the computing device 120 may obtain the set of spatial coordinates 145 and the set of reference descriptors 147 corresponding to the set of keypoints 143 in the reference image 140. In some embodiments, the computing device 120 or another entity (for example, another computing device) may have generated and stored a set of keypoints, a set of reference descriptors and a set of spatial coordinates in association for each reference image in the set of reference images of the external environment 105. In the context of the present disclosure, image data including such data or information may also be referred to as a localization map. In this situation, using the reference image 140 as an index, the computing device 120 may retrieve in the localization map the set of keypoints 143, the set of spatial coordinates 145 and the set of reference descriptors 147 corresponding to the reference image 140. Reference will be made to FIGS. 10 and 11 hereinafter to describe those embodiments.

In other embodiments, the computing device 120 may not have a pre-stored localization map, or may be unable to obtain the localization map. In such a circumstance, the computing device 120 may first extract the set of keypoints 143 from the reference image 140 and then obtain the set of spatial coordinates 145 and the set of reference descriptors 147 associated with the set of keypoints 143. More specifically, the computing device 120 may employ various appropriate keypoint selection algorithms for selecting the set of keypoints 143 from a set of points in the reference image 140. In some embodiments, in order to avoid the impact of uneven distribution of the set of the keypoints 143 in the reference image 140 on the subsequent localization effect of the vehicle 110, the computing device 120 may select, based on a Farthest Point Sampling (FPS) algorithm, the set of keypoints 143 from the set of points in the reference image 140 to achieve uniform sampling of the set of points in the reference image 140.

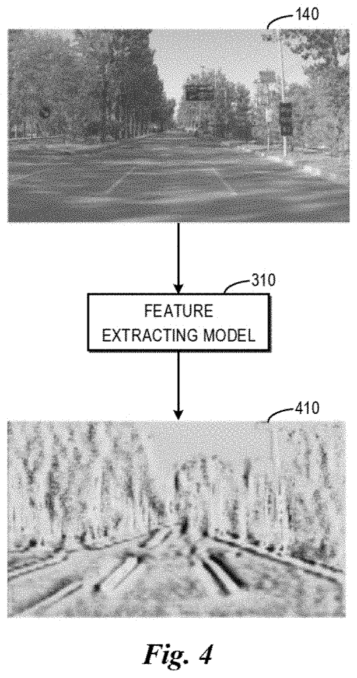

To obtain the set of reference descriptors 147 associated with the set of keypoints 143, the computing device 120 may first determine a reference descriptor map of the reference image 140 and then obtain, from the reference descriptor map, a plurality of reference descriptors (namely, the set of reference descriptors 147) corresponding to respective keypoints of the set of keypoints 143. For this purpose, the computing device 120 may generate the reference descriptor map from the reference image 140 in the same manner as that for generating the image descriptor map 160 from the captured image 130, as described above. In some embodiments, in a similar way as the embodiments described in FIG. 3, the computing device 120 may input the reference image 140 into the feature extraction model 310 to gain the reference descriptor map of the reference image 140 at the output of the feature extraction model 310. Reference will be made to FIG. 4 below to further describe such embodiments.

FIG. 4 illustrates an example of obtaining a reference descriptor map 410 by inputting the reference image 140 into the feature extraction model 310, according to embodiments of the present disclosure. In FIG. 4, in order to more intuitively and clearly display the reference image 140 and the reference descriptor map 410, the reference image 140 is represented as an image captured when the capturing device is capturing data on a real road, and the reference descriptor map 410 is a reference descriptor map presented after visualization processing. As shown in FIG. 4, the reference image 140 may be input into the trained feature extraction model 310, and the feature extraction model 310 may process the input reference image 140 to extract image features therein and thus generate the reference descriptor map 410. Subsequently, the feature extraction model 310 may output the generated reference descriptor map 410.

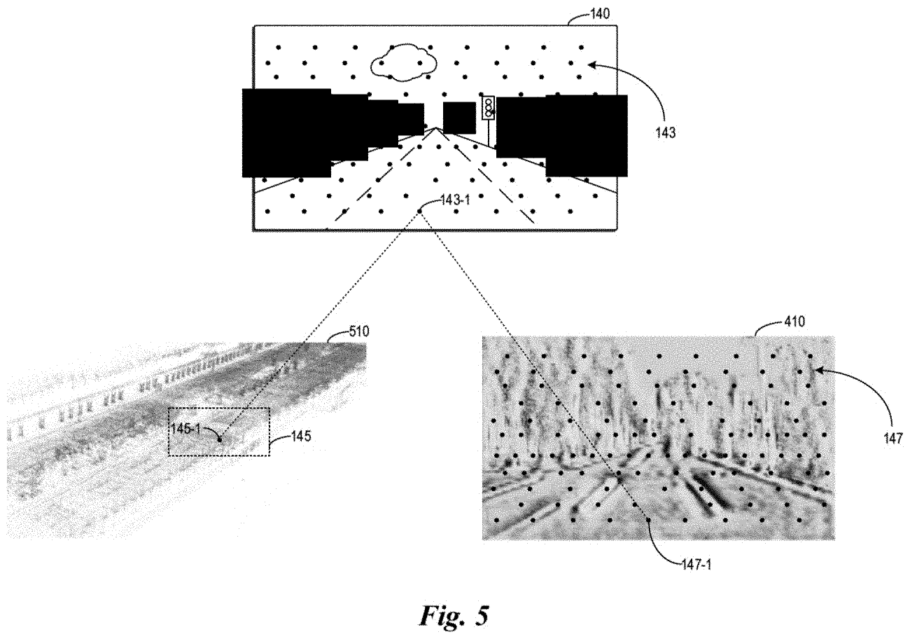

In addition to the set of reference descriptors 147, the computing device 120 may obtain the set of spatial coordinates 145 corresponding to the set of keypoints 143 of the reference image 140, for example, three-dimensional coordinates of three-dimensional spatial points corresponding to respective keypoints in the set of keypoints 143. It is worth noting that, since the reference image 140 of the external environment 105 is pre-captured by the capturing device, the capturing device may obtain three-dimensional coordinate information (for example, a point cloud) of various objects in the external environment 105 simultaneously when capturing the reference image 140. Accordingly, the computing device 120 can determine, based on projection, three-dimensional reconstruction, or the like, a spatial coordinate corresponding to each point in the reference image 140. For the set of keypoints 143 in the reference image 140, the computing device 120 may determine a plurality of spatial coordinates (namely, the set of spatial coordinates 145) corresponding to respective keypoints in the set of keypoints 143. Reference will be made to FIG. 5 below to further describe a specific example of the set of keypoints 143, the set of spatial coordinates 145 and the set of reference descriptors 147 of the reference image 140.

FIG. 5 illustrates an example of the set of keypoints 143 in the reference image 140 as well as the set of reference descriptors 147 and the set of spatial coordinates 145 associated with the set of keypoints 143, according to embodiments of the present disclosure. It should be appreciated that the specific distribution of the set of keypoints 143 in the reference image 140, as depicted in FIG. 5, is merely an example, without suggesting any limitation to the scope of the present disclosure. In other embodiments, the set of keypoints 143 may have any distribution in the reference image 140. For example, as compared with the distribution as shown in FIG. 5, the set of keypoints 143 may have a denser or sparser distribution in the reference image 140. As another example, the set of keypoints 143 may be distributed more densely at the edge of an object, rather than distributed substantially evenly in the reference image 140.

As an example, FIG. 5 shows the reference image 140, the reference descriptor map 410 and a point cloud 510 associated with the external environment 105. In the reference image 140, the set of keypoints 143 includes a keypoint 143-1 which is also referred to as a first keypoint 143-1 herein. Through three-dimensional reconstruction, projection, or the like, the computing device 120 may determine a first spatial coordinate 145-1 corresponding to the first keypoint 143-1 from the point cloud 510. Likewise, for other keypoints in the set of keypoints 143, the computing device 120 may determine their corresponding spatial coordinates from the point cloud 510, thereby obtaining the set of spatial coordinates 145. On the other hand, since the descriptors in the reference descriptor map 410 correspond to the image points in the reference image 140, the computing device 120 may determine a first reference descriptor 147-1 corresponding to the first keypoint 143-1 from the reference descriptor map 410. In a similar manner, for other keypoints in the set of keypoints 143, the computing device 120 may determine their corresponding reference descriptors from the reference descriptor map 410, thereby obtaining the set of reference descriptors 147.

As discussed above, the predicted pose 150 of the vehicle 110 may be a relatively inaccurate pose with accuracy less than a predetermined threshold. However, considering that the predicted pose 150 is gained through measurement or the example process 200, there may not be a significant difference between the predicted pose 150 and the real pose of the vehicle 110. In other words, the predicted pose 150 of the vehicle 110 may be regarded as “neighboring” the real pose. More specifically, in the embodiments of the present disclosure, if the pose of the vehicle 110 is regarded as a point in a multidimensional (for example, six-dimensional) space, it would be considered that the real pose of the vehicle 110 is neighboring the predicted pose 150 in the six-dimensional space. In a simplified case, assuming that the vertical coordinate, pitch angle and roll angle in the pose of the vehicle 110 are known, it should be considered that the pose of the vehicle 110 is a point in a three-dimensional space (including an x coordinate, a y coordinate and a yaw angle), and the real pose of the vehicle 110 is neighboring the predicted pose 150 in the three-dimensional space. As a result, assuming that the predicted pose 150 is a point in a multidimensional space, the computing device 120 may select a plurality of points neighboring the point and then update the predicted pose 150 based on the plurality of points, in order to obtain an updated predicted pose 180 much closer to the real pose of the vehicle 110.

Referring back to FIG. 2, in light of such an idea, the computing device 120 may obtain a plurality of candidate poses 155 by offsetting the predicted pose 150 at block 230. In general, the computing device 120 may obtain the plurality of candidate poses 155 neighboring the predicted pose 150 in any appropriate offsetting manner. For example, the computing device 120 may perform offsetting randomly in the vicinity of the predicted pose 150 to gain a predetermined number of candidate poses 155. As another example, the computing device 120 may offset uniformly in a predetermined offset in multiple dimensions of the predicted pose 150, so as to determine the plurality of candidate poses 155 around the predicted pose 150. Selection of the candidate poses 155 will be described below in an example in which the predicted pose 150 has three dimensions including a horizontal axis, a longitudinal axis and a yaw angle axis. Nonetheless, it should be appreciated that embodiments of the present disclosure are equally applicable to offsetting the predicted pose 150 having any appropriate number of dimensions, so as to gain the plurality of candidate poses 155. In addition, it is worth noting that, in embodiments of the present disclosure, the plurality of candidate poses 155 may be represented by absolute coordinates or offsets relative to the predicted pose 150. The two types of representations are substantially consistent, which can be readily converted into each other.

More specifically, in the case that the predicted pose 150 includes three degrees of freedom, namely the horizontal axis, the longitudinal axis and the yaw angle axis, the computing device 120 may take a horizontal coordinate, a longitudinal coordinate and a yaw angle of the predicted pose 150 as a center and offset from the center in the three dimensions of the horizontal axis, the longitudinal axis and the yaw angle axis, using respective predetermined offset units and within respective predetermined maximum offset ranges, so as to determine the plurality of candidate poses 155. For example, assuming that the predicted pose 150 of the vehicle 110 has a horizontal coordinate of 10 m, a longitudinal coordinate of 10 m, and a yaw angle of 10°, which can be represented as (10 m, 10 m, 10). Then, one of the plurality of candidate poses 155 obtained by offsetting the predicted pose 155 may be (10.5 m, 10 m, 10°), indicating that the candidate pose is offset 0.5 m in the horizontal axis relative to the predicted pose 150 and remains unchanged in the longitudinal coordinate and the yaw angle. In this way, the computing device 120 may perform offsetting uniformly in the vicinity of the predicted pose 150 in a fixed manner to obtain the plurality of candidate poses 155, thereby increasing the probability that the plurality of candidate poses 155 cover the real pose of the vehicle 110. In addition, when the example process 200 is used iteratively to determine the pose of the vehicle 110 with accuracy meeting the requirement, the manner in which the candidate poses 155 are obtained by performing offsetting uniformly in the vicinity of the predicted pose 150 can accelerate convergence of the localization results of the vehicle 110 to the pose.

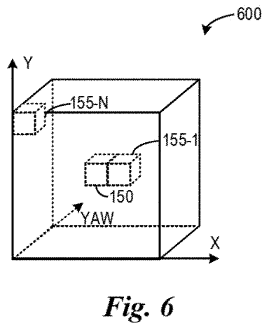

Moreover, it should be noted that the predetermined offset units and the predetermined maximum offset ranges used herein may be determined based on a specific system environment and accuracy requirement. For example, if the computing device 120 iteratively updates the predicted pose 150 using the example method 200, the predetermined offset units and the predetermined maximum offset ranges may be reduced gradually in the iterations. This is because the predicted pose of the vehicle 110 becomes more precise with the increasing number of iterations and is getting closer to the real pose of the vehicle 110 accordingly. In some embodiments, in order to better represent and process data associated with the plurality of candidate poses 155 (for example, probabilities of the plurality of candidate poses 155 being the real pose, and the like), the plurality of candidate poses 155 may be represented in the form of three-dimensional cubes having a center at the predicted pose 150. Reference will be made to FIG. 6 below to describe such an example in detail.

FIG. 6 illustrates a schematic diagram of the predicted pose 150 and the plurality of candidate poses 155 represented in the form of a cube 600 according to embodiments of the present disclosure. As shown in FIG. 6, in a coordinate system consisting of an x axis (namely, a horizontal axis), a y axis (namely, a longitudinal axis) and a yaw axis (namely, an axis of yaw angle), the cube 600 may be comprised of several small cubes (for example, 150 and 155-1 to 155-N as marked in FIG. 6). The small cube in the center of the cube 600 may represent the predicted pose 150 of the vehicle 110 and thus be referred to as small cube 150. As an example, a small cube 155-1 representing a first candidate pose 155-1 is adjacent to the small cube 150 in a positive direction of the horizontal axis and identical to the small cube 150 in the longitudinal coordinate and the yaw angle. In other words, as compared to the predicted pose 150, the first candidate pose 155-1 is offset by a predetermined unit of offset (also referred to as predetermined stride size) in the positive direction of the horizontal axis.

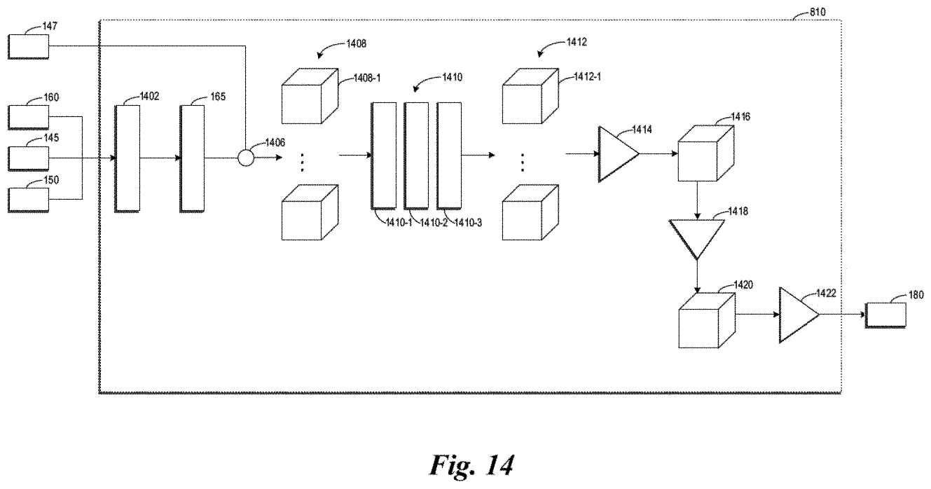

Likewise, as another example, the small cube 155-N representing the N^{th} candidate pose 155-N is offset by a predetermined maximum offset from the small cube 150 in a negative direction of the horizontal axis, offset by a predetermined maximum offset from the small cube 150 in a positive direction of the longitudinal axis, and offset by a predetermined maximum offset from the small cube 150 in a negative direction of the axis of the yaw angle. In this way, the plurality of candidate poses 155 obtained through offsetting the predicted pose 150 may be represented in the form of small cubes included in the cube 600. In some embodiments, cost volumes of the candidate poses 155 represented in a similar form may be processed advantageously through a 3D Convolutional Neural Network (3D CNN). Reference will be made to FIG. 14 hereinafter to describe such examples in detail.

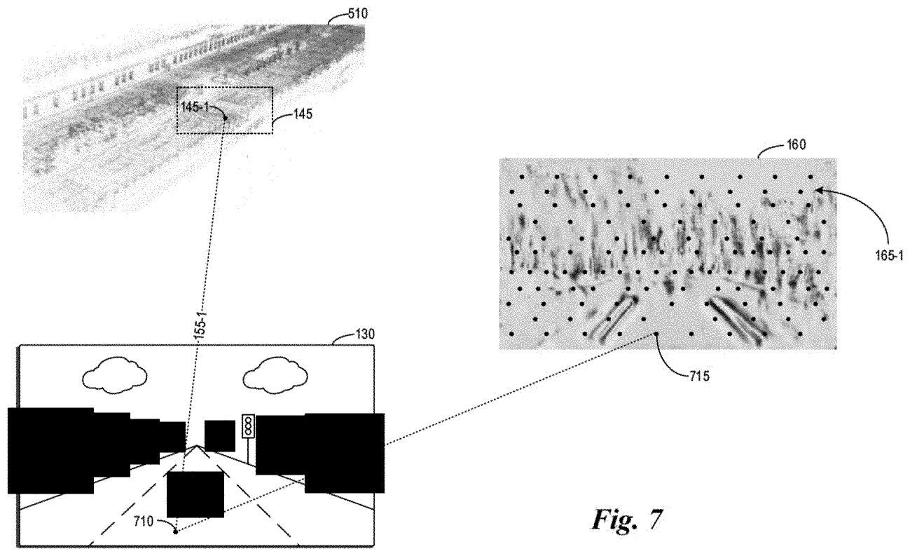

Referring back to FIG. 2, at block 230, after obtaining the plurality of candidate poses 155 by offsetting the predicted pose 150, and assuming that the vehicle 110 is in the plurality of candidate poses 155, respectively, the computing device 120 may determine a plurality of sets of image descriptors 165 corresponding to the set of spatial coordinates 145, and the plurality of sets of image descriptors 165 belong to the image descriptor map 160. In other words, assuming that the vehicle 110 is in a certain candidate pose of the plurality of candidate poses 155, the computing device 120 may determine, in the image descriptor map 160, a plurality of descriptors corresponding to respective spatial coordinates in the set of spatial coordinates 145, namely a set of image descriptors corresponding to the candidate pose. Due to the presence of the plurality of candidate poses 155, the computing device 120 may determine a plurality of sets of image descriptors. Reference will be made to FIG. 7 below to describe, taking the first candidate pose 155-1 of the plurality of candidate poses 155 as an example, how the computing device 120 determines a set of image descriptors 165-1 corresponding to the set of spatial coordinates 145 assuming that the vehicle 110 is in the first candidate pose 155-1.

FIG. 7 illustrates a schematic diagram of determining the first set of image descriptors 165-1 by projecting the set of spatial coordinates 145 onto the captured image 130 on the assumption that the vehicle 110 is in the first candidate pose 155-1, according to embodiments of the present disclosure. As shown in FIG. 7, in order to determine a probability that the first candidate pose 155-1 of the plurality of candidate poses 155 is the real pose of the vehicle 110, the computing device 120 may assume that the vehicle 110 is in the first candidate pose 155-1. The computing device 120 may then determine related projection parameters or data for projecting the set of spatial coordinates 145 onto the captured image 130 when the vehicle 110 is in the first candidate pose 155-1. For example, the projection parameters or data may include, but are not limited to, a conversion relation between the coordinate system of the vehicle 110 and the coordinate system of the imaging device of the vehicle 110, a conversion relation between the coordinate system of the vehicle 110 and the spatial coordinate system, various parameters of the imaging device of the vehicle 110, and the like.

Using these projection parameters or data, the computing device 120 may project the first spatial coordinate 145-1 in the set of spatial coordinates 145 onto the captured image 130, so as to determine a projection point 710 of the first spatial coordinate 145-1. Thereafter, in the image descriptor map 160 of the captured image 130, the computing device 120 may determine an image descriptor 715 corresponding to the projection point 710 to obtain an image descriptor of the set of image descriptors 165-1. Likewise, for other spatial coordinates in the set of spatial coordinates 145, the computing device 120 may determine image descriptors corresponding to these spatial coordinates and thus obtain the set of image descriptors 165-1. It should be pointed out that, although it is described herein that the computing device 120 first projects the set of spatial coordinates 145 onto the captured image 130 and then determines the corresponding set of image descriptors 165-1 from the image descriptor map 160, such a manner is merely an example, without suggesting any limitation to the scope of the present disclosure. In other embodiments, the computing device 120 may project the set of spatial coordinates 145 directly onto the image descriptor map 160 to determine the set of image descriptors 165-1 corresponding to the set of spatial coordinates 145.

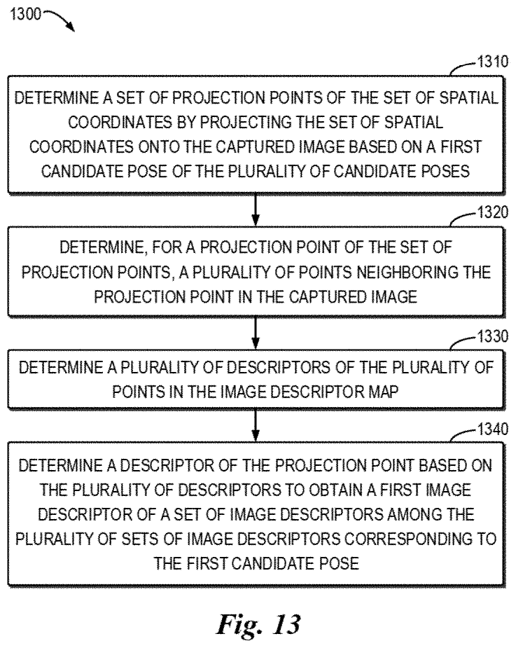

In addition, it is worth noting that, in some embodiments, the projection point 710 of the first spatial coordinate 145-1 in the captured image 130 may correspond exactly to an image point in the captured image 130, and the image descriptor 715 corresponding to the first spatial coordinate 145-1 thus can be determined directly from the image descriptor map 160. Nonetheless, in other embodiments, the projection point 710 of the first spatial coordinate 145-1 in the captured image 130 may not correspond directly to a certain image point in the captured image 130, but falls among a plurality of image points in the captured image 130. In those embodiments, the computing device 120 may determine the image descriptor 715 corresponding to the projection point 710 based on a plurality of descriptors in the image descriptor map 160 corresponding to the plurality of image points around the projection point 710. Reference will be made to FIG. 13 hereinafter to describe such an example.

Referring back to FIG. 2, at block 240, the computing device 120 may determine a plurality of similarities 170 between the plurality of sets of image descriptors 165 and the set of reference descriptors 147. In other words, for a set of image descriptors among the plurality of sets of image descriptors 165, the computing device 120 may determine a similarity between the set of image descriptors and the set of reference descriptors 147, thereby determining a similarity of the plurality of similarities 170. For example, referring to FIG. 1, for the first set of image descriptors 165-1 among the plurality of sets of image descriptors 165, the computing device 120 may determine a first similarity 170-1 between the first set of image descriptors 165-1 and the set of reference descriptors 147. For other sets of image descriptors among the plurality of sets of image descriptors 165, the computing device 120 may determine likewise the similarities between them and the set of reference descriptors 147 to finally obtain the plurality of similarities 170. It should be appreciated that the plurality of sets of image descriptors 165 are obtained assuming that the vehicle 110 is in the plurality of candidate poses 155, respectively, and thus the plurality of similarities 170 corresponding to the plurality of sets of image descriptors 165 actually also correspond to the plurality of candidate poses 155.

Generally, the computing device 120 may determine the first similarity 170-1 between the first set of image descriptors 165-1 and the set of reference descriptors 147 in any appropriate manner. For example, the computing device 120 may compute the first similarity 170-1 as a difference between a mean value of the first set of image descriptors 165-1 and a mean value of the set of the reference descriptors 147. As another example, the computing device 120 may compute the first similarity 170-1 based on some descriptors of the first set of image descriptors 165-1 and corresponding descriptors of the set of reference descriptors 147. As a further example, the computing device 120 may determine a plurality of differences between corresponding descriptors in the first set of image descriptors 165-1 and the set of reference descriptors 147 and then determine the first similarity 170-1 based on the plurality of differences. In the following, the first set of image descriptors 165-1 will be taken as an example to illustrate determining the first similarity 170-1 between the first set of image descriptors 165-1 and the set of reference descriptors 147 in such a manner.

As aforementioned, the first set of image descriptors 165-1 includes a plurality of image descriptors which correspond to respective spatial coordinates in the set of spatial coordinates 145. On the other hand, the set of spatial coordinates 145 and the set of reference descriptors 147 are also in a correspondence relation. In other words, the first set of image descriptors 165-1 and the set of reference descriptors 147 both correspond to the set of spatial coordinates 145. For example, referring to FIGS. 5 and 7, the first set of spatial coordinates 145-1 among the set of spatial coordinates 145 corresponds to the reference descriptor 147-1 among the set of reference descriptors 147 as well as the image descriptor 715 of the first set of image descriptors 165-1. That is, each image descriptor in the first set of image descriptors 165-1 has a corresponding reference descriptor in the set of reference descriptors 147. As a result, the first similarity 170-1 between the first set of image descriptors 165-1 and the set of reference descriptors 147 may be determined synthetically based on the differences between all pairs of corresponding descriptors thereof. In this way, since all the differences between all the pairs of corresponding descriptors are accounted for, the accuracy of the first similarity 170-1 between the first set of image descriptors 165-1 and the set of reference descriptors 147 can be improved.

More specifically, for the first set of image descriptors 165-1 among the plurality of sets of image descriptors 165, the computing device 120 may determine a plurality of differences between respective image descriptors in the first set of image descriptors 165-1 and corresponding reference descriptors in the set of reference descriptors 147. For example, in the case that the image descriptors and the reference descriptors are represented in the form of an n-dimensional vector, for each pair of corresponding “image descriptor-reference descriptor,” the computing device 120 may calculate the difference between the two descriptors as an L2 distance between the two paired descriptors. Using the L2 distance between descriptors to represent a difference between descriptors is merely an example, without suggesting any limitation to the scope of the present disclosure. In other embodiments, the computing device 120 may also utilize any other appropriate metric to represent a difference between two descriptors.

Subsequent to determining the plurality of differences associated with the plurality of descriptor pairs between the first set of image descriptors 165-1 and the set of reference descriptors 147, the computing device 120 may determine, based on the plurality of differences, a similarity between the first set of image descriptors 165-1 and the set of reference descriptors 147, namely the first similarity 170-1 of the plurality of similarities 170. For example, in a straightforward manner, the computing device 120 may sum up the plurality of differences to obtain a total difference of the plurality of descriptor pairs for representing the first similarity 170-1. In other embodiments, the computing device 120 may obtain the first similarity 170-1 from the above-mentioned plurality of differences in any other appropriate manner as long as the plurality of differences are taken into consideration for obtaining the first similarity 170-1. For example, the computing device 120 may perform averaging, weighted averaging, or weighted summing on the plurality of differences, and average or sum up some differences falling within a predetermined range, or the like.

At block 250, after obtaining the plurality of similarities 170 corresponding to the plurality of candidate poses 155, the computing device 120 may update the predicted pose 155 based on the plurality of candidate poses 155 and the plurality of similarities 170, in order to obtain the updated predicted pose 180. It should be appreciated that the plurality of similarities 170 actually embody respective approach degrees of the plurality of candidate poses 155 to the real pose of the vehicle 110 when capturing the captured image 130. For example, the first similarity 170-1 corresponding to the first candidate pose 155-1 may reflect an approach degree of the first candidate pose 155-1 to the real pose of the vehicle 110. In other words, the plurality of similarities 170 may be considered as embodying probabilities that the plurality of candidate poses 155 are the real pose of the vehicle 110, respectively. As such, the computing device 120 may update the predicted pose 150 based on the plurality of candidate poses 155 and the respective plurality of similarities 170, namely, may determine a new predicted pose as a more accurate updated predicted pose 180.

As an example, the computing device 120 may determine, from the plurality of similarities 170, respective probabilities of the plurality of candidate poses 155 being the real pose of the vehicle 110. For example, the computing device 120 may normalize the plurality of similarities 170 to make the sum of the plurality normalized similarities 170 equal to 1. The computing device 120 may then take the plurality of normalized similarities 170 as respective probabilities of the plurality of candidate poses 155. It should be appreciated that the normalization of the plurality of similarities 170 herein is merely an example, without suggesting any limitation to the scope of the present disclosure. In other embodiments, the computing device 120 may apply other appropriate computing manners (for example, a weighted normalization of the plurality of similarities 170, or the like) to obtain, from the plurality of similarities 170, the respective probabilities of the plurality of candidate poses 155 being the real pose.

After determining the respective probabilities of the plurality of candidate poses 155 being the real pose, the computing device 120 may determine, from the plurality of candidate poses 155 and their respective probabilities, an expected pose of the vehicle 110 as the updated predicted pose 180. As such, all the candidate poses 155 are accounted for the ultimately updated predicted pose 180 according to respective probabilities, so as to enhance the accuracy of the updated predicted pose 180. It is to be appreciated that the expected pose being determined by the computing device 120 as the updated predicted pose 180 is merely an example, without suggesting any limitation to the scope of the present disclosure. In other embodiments, the computing device 120 may determine the updated predicted pose 180 in other appropriate manners. For example, the computing device 120 may directly determine the candidate pose having the greatest probability as the updated predicted pose 180, or determine the updated predicted pose 180 based on several candidate poses having probabilities ranked in the top, and so on. In addition, it should be pointed out that, if the plurality of candidate poses 155 are represented in the form of an offset relative to the predicted pose 150 in the example process 200, then the computing device 120 may obtain the updated predicted pose 180 by offsetting the predicted pose 150 by an offset determined according to the example process 200.

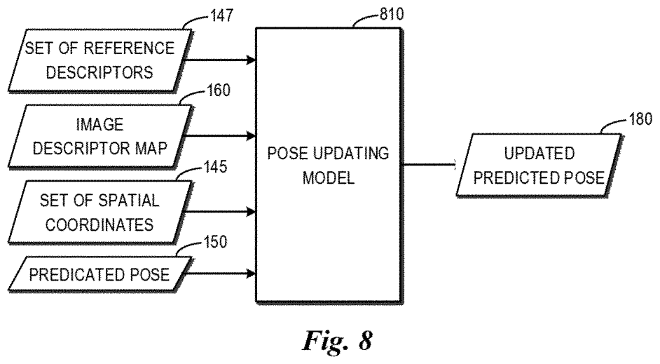

In the embodiments as described above, at blocks 230 through 250 of the example process 200, the computing device 120 updates the predicted pose 150 by processing, step by step, the set of spatial coordinates 145, the set of reference descriptors 147, the predicted pose 150, the image descriptor map 160, and other data, so as to gain the updated predicted pose 180. In other embodiments, the computing device 120 may complete the processing operations at blocks 230 through 250 in a modular way (namely, a processing module for performing a pose updating function may be built to process the data as mentioned above), thereby obtaining the updated predicted pose 180. In the context of the present disclosure, the processing module may also be referred to as a pose updating model or Feature Matching (FM) module. In some embodiments, the pose updating model may be implemented using a machine learning model based on deep learning. Reference will be made below to FIG. 8 to describe such an example.

FIG. 8 illustrates a schematic diagram of obtaining the updated predicted pose 180 by inputting the set of spatial coordinates 145, the set of reference descriptors 147, the predicted pose 150 and the image descriptor map 160 into a pose updating model 810, according to embodiments of the present disclosure. In some embodiments, the pose updating model 810 may be implemented at the computing device 120, this is the situation depicted in FIG. 1. In other embodiments, the pose updating model 810 may also be implemented in an entity (for example, another computing device) other than the computing device 120. In this event, the computing device 120 may supply the set of spatial coordinates 145, the set of reference descriptors 147, the predicted pose 150, the image descriptor map 160, and the like to the entity implementing the pose updating model 810 and then receive the updated predicted pose 180 from the entity. As used herein, the pose updating model 810 may also be referred to as a feature matching model 810 or a pose prediction model 810.

In some embodiments, the pose updating model 810 is a deep learning model trained using training data, and a more accurate updated predicted pose 180 thus can be determined using the trained pose updating model 810. As an example, the pose updating model 810 may be trained based on a difference between an estimated pose of the vehicle 110 finally obtained through the example process 200 and the real pose of the vehicle 110, such that the updated predicted pose 180 generated by the trained pose updating model 810 can be closer to the real pose of the vehicle 110. For instance, in some embodiments, the pose updating model 810 may be a part of a localization system for locating the vehicle 110, and the localization system may include machine learning models for other functions, such as the feature extraction model 310 as described above. In those embodiments, the computing device 120 can implement, based on the difference between the estimated pose of the vehicle 110 determined by the localization system and the real pose of the vehicle 110, an end-to-end training of the feature extraction model 310 together with the pose updating model 810. Reference will be made to FIG. 15 hereinafter to describe such embodiments in detail.

### Example Feature Extraction Model

As mentioned in the description with reference to FIGS. 3 and 4, in some embodiments, the feature extraction model 310 for extracting the image descriptor map 160 from the captured image 130 or the reference descriptor map 410 from the reference image 140 may be implemented using a convolutional neural network based on a Feature Pyramid Network (FPN). Reference will be made to FIG. 9 below to describe such an example. It should be appreciated that the feature pyramid network architecture is only example network architecture of the feature extraction model 310 in embodiments of the present disclosure, without suggesting any limitation to the scope of the present disclosure. In other embodiments, the feature extraction model 310 may be a convolutional neural network of any other appropriate structure, or any other appropriate machine learning model.

FIG. 9 illustrates an example structure of the feature extraction model 310 according to embodiments of the present disclosure. An example in which the captured image 130 is used as an input for outputting the image descriptor map 160 will be employed below to describe the feature extraction model 310. However, it should be appreciated that the feature extraction model 310 is equally applicable to using the reference image 140 as the input for outputting the reference descriptor map 410. As shown in FIG. 9, the feature extraction model 310 having the feature pyramid network architecture may include an encoder 950 and a decoder 960, and the decoder 960 may include lateral connection layers 930 and 932. The lateral connection layers 930 and 932 may merge feature maps of the same spatial size from the encoder 950 path to the decoder 960, such that the feature pyramid network of the feature extraction model 310 can enhance high-level semantic features at all scales, and a more powerful feature extractor 310 thus can be attained.

In the example of FIG. 9, the captured image 130 may be input to the encoder 950 of the feature extraction model 310, and the encoder 950 may include four stages. The first stage may include two convolutional layers 902 and 904. The convolutional layer 902 may have 16 channels, 3 kernels and a stride size of 1, and the convolutional layer 904 may have 32 channels, 3 kernels and a stride size of 1. Starting from the second stage, each stage may include a convolutional layer and two residual blocks, and each residual block may include two convolutional layers. For example, the second stage may include a convolutional layer 906 and two residual blocks 908 and 910, the third stage may include a convolutional layer 912 and two residual blocks 914 and 916, and the fourth stage may include a convolutional layer 918 and two residual blocks 920 and 922.

In some embodiments, the convolutional layers 902, 904, 906, 912 and 918 may be two-dimensional (2D) convolutional layers while the residual blocks 908, 910, 914, 916, 920 and 922 may each include two 3><3 convolutional layers. Therefore, the encoder 950 may include 17 convolutional layers in total. Moreover, in some embodiments, the convolutional layer 906 may have 64 channels, 3 kernels and a stride size of 2 while the convolutional layers 912 and 918 may each have 128 channels, 3 kernels and a stride size of 2. The residual blocks 908 and 910 may each have 64 channels and 3 kernels while the residual blocks 914, 916, 920 and 922 may each have 128 channels and 3 kernels.

In the decoder 960, following the convolutional layer 924, two upsampling layers 926 and 928 are applied to generate or hallucinate higher resolution features from coarser but semantically stronger features. Through the above-mentioned lateral connection layers 930 and 932, the features of the same resolution from the encoder 950 may be merged to enhance those features in the decoder 960. The outputs of the decoder 960 may be feature maps with different resolutions of the original image (namely, the captured image 130). In some embodiments, the convolutional layer 924 may be a 2D convolutional layer, which may have 32 channels, 1 kernel and a stride size of 1. In some embodiments, the lateral connection layers 930 and 932 may each be a 2D convolutional layer, which have 32 channels, 1 kernel and a stride size of 1.

The outputs of the decoder 960 may be fed back into a network head 934 which may be responsible for extracting descriptors and outputting the image descriptor map 160. In some embodiments, the network head 934 may include two convolutional layers, such as 2D convolutional layers. The preceding convolutional layer may have 32 channels, 1 kernel and a stride size of 1, while the subsequent convolutional layer may have 8 channels, 1 kernel and a stride size of 1. In some embodiments, feature descriptors in the image descriptor map 160 output via the network head 934 may be represented as D-dimensional vectors. These feature descriptors can still achieve robustness matching under severe object appearance changes caused by varying lighting conditions or viewpoint conditions. For example, the image descriptor map 160 may be represented as a three-dimensional (3D) tensor

$$F ∈ {R}^{\frac{H}{s} \times \frac{W}{s} \times D} ,$$

where H and W represent resolutions in height and width of the input captured image 130, s ∈ 2, 4, 8 is a scale factor, D=8 is a descriptor dimension size in the image descriptor map 160, and R denotes the set of real numbers.

With the example feature pyramid network architecture as depicted in FIG. 9, the image descriptor map 160 and the reference descriptor map 410 extracted by the feature extraction model 310 from the captured image 130 and the reference image 140, respectively, may include feature descriptors more robust in terms of feature matching. Therefore, when applied to the technical solution for vehicle localization in embodiments of the present disclosure, the feature extraction model 310 having the above structure may be helpful to improve the robustness of vehicle localization.

### Example Process of Obtaining Set of Reference Descriptors and Set of Spatial Coordinates

As mentioned in the description with reference to block 220 of the example process 200, in some embodiments, the computing device 120 or another entity (for example, another computing device) may generate and store a set of keypoints, a set of reference descriptors and a set of spatial coordinates associated with each reference image in the set of reference images of the external environment 105. As used herein, a map associated with the external environment 105, including data or content, such as sets of keypoints, sets of reference descriptors, sets of spatial coordinates, and the like of a plurality of reference images, may be referred to as a localization map. Therefore, in those embodiments, for the set of keypoints 143 of the reference image 140, the computing device 120 may obtain the corresponding set of spatial coordinates 145 and the corresponding set of reference descriptors 147 from the localization map of the external environment 105. References will be made to FIGS. 10 and 11 below to describe those embodiments in detail.

FIG. 10 illustrates a flowchart of an example process 1000 for obtaining the set of reference descriptors 147 and the set of spatial coordinates 145 corresponding to the set of keypoints 143, according to embodiments of the present disclosure. In some embodiments, the example process 1000 may be implemented by the computing device 120 of the vehicle 110 in the example environment 100, for example, by a processor or processing unit of the computing device 120, or by various functional modules of the computing device 120. In other embodiments, the example process 1000 may be implemented by a computing device independent of the example environment 100, or by other units or modules in the example environment 100.

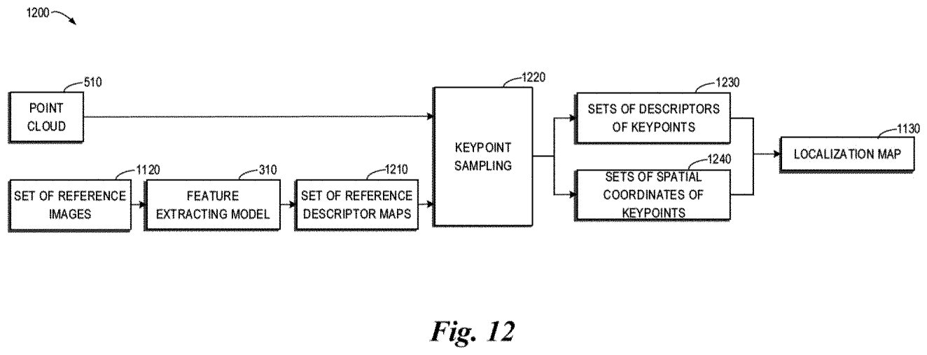

FIG. 11 illustrates a schematic diagram of capturing, by a capturing vehicle 1110, a set of reference images 1120 of the external environment 105 and generating a localization map 1130, according to embodiments of the present disclosure. As shown in FIG. 11, at some time before the vehicle 110 to be located captures the captured image 130, the capturing vehicle 1110 may perform a data capture task for the external environment 105. In some embodiments, the capturing vehicle 1110 may capture a set of reference images 1120 of the external environment 105 during traveling. For example, the set of reference images 1120 may be in the form of a video. The set of reference images 1120 may be in the form of multiple consecutive images. As shown, the reference image 140 may be included in the set of reference images 1120. Furthermore, the capturing vehicle 1110 may use a laser radar or the like to obtain the point cloud 510 of the external environment 105. Then, the computing device 120 or another computing device may generate the localization map 1130 based on the set of reference images 1120 and the point cloud 510. Reference will be made to FIG. 12 hereinafter to describe an example manufacturing process of the localization map 1130 in detail.

In some embodiments, each reference image in the set of reference images 1120 may include a set of keypoints, which may be stored in the localization map 1130. Moreover, the localization map 1130 further stores a set of reference descriptors and a set of spatial coordinates associated with the set of keypoints. For example, the localization map 1130 may store the set of keypoints in the reference image 140, as well as the set of reference descriptors 147 and the set of spatial coordinates 145 associated with the set of keypoints 143, and the set of spatial coordinates 145 may be determined by projecting the laser radar point cloud 510 to the reference image 140.

Referring to FIGS. 10 and 11, it is assumed that the localization map 1130 is available for locating the vehicle 110, and the computing device 120 has already obtained the captured image 130 of the external environment 105 for locating the vehicle 110. In this event, at block 1010 of FIG. 10, the computing device 120 of the vehicle 110 may obtain the set of reference images 1120 associated with the external environment 105. For example, the computing device 120 may obtain the set of reference images 1120 from the capturing vehicle 1110 captured in the set of reference images 1120. As another example, the set of reference images 1120 may be stored at another device, and thus the computing device 120 can obtain the set of reference images 1120 from the device storing the set of reference images 1120.

At block 1020 of FIG. 10, the computing device 120 may select, based on the predicted pose 150 of the vehicle 110, a reference image corresponding to the captured image 130 from the set of reference images 1120. In the context of the present disclosure, it is assumed that the reference image corresponding to the captured image 130 selected by the computing device 120 is the reference image 140. In some embodiments, the captured image 130 “corresponding to” the reference image 140 as used herein may refer to the fact that a difference between the pose in which the capturing vehicle 1110 is capturing the reference image 140 and the predicted pose 150 of the vehicle 110 is small enough, for example, less than a predetermined threshold. Since the set of reference images 1120 is captured when the capturing vehicle 1110 is performing a measurement task, pose information of the capturing vehicle 1110 when each reference image in the set of reference images 1120 is captured is retrievable. Consequently, in some embodiments, from all the reference images in the set of reference images 1120, the computing device 120 may determine and select the reference image 140 associated with the capturing pose of the capturing vehicle 1110 closest to the predicted pose 150. In some circumstances, the pose of the capturing vehicle 1110 when capturing the reference image 140 may be identical to the predicted pose 150 of the vehicle 110.

As aforementioned, in the localization map 1130, the set of keypoints 143 of the reference image 140, the set of spatial coordinates 145 and the set of reference descriptors 147 are stored in association. Therefore, at block 1030 of FIG. 10, subsequent to determining the reference image 140 corresponding to the captured image 130 from the set of reference images 1120, the computing device 120 may obtain, from the localization map 1130, the set of spatial coordinates 145 and the set of reference descriptors 147 corresponding to the set of keypoints 143 of the reference image 140. For example, using an identifier of the reference image 140, the computing device 120 may retrieve the set of keypoints 143, the set of spatial coordinates 145 and the set of reference descriptors 147 from the localization map 1130.

Through the example process 1000, if the localization map 1130 is available for locating the vehicle 110, the computing device 120 can directly retrieve, based on the reference image 140 corresponding to the captured image 130, the set of spatial coordinates 145 and the set of reference descriptors 147. There is no need to utilize the feature extraction model 310 to generate the set of reference descriptors 147, or adopt a three-dimensional reconstruction method or the like to obtain the set of spatial coordinates 145. In this way, the computing loads and overhead of the computing device 120 of the vehicle 110 can be reduced significantly, and the computing device 120 can spend much less time on locating the vehicle 110.

### Example Process of Generating Localization Map

As mentioned in the description with reference to FIG. 11, in some embodiments, the computing device 120 or another computing device may generate the localization map 1130 based on the set of reference images 1120 and the point cloud 510. In those embodiments, the prebuilt localization map 1130 may be used as an input to the localization system to locate the vehicle 110. Essentially, the localization map 1130 may be considered as encoding related information of the external environment 105. For example, the localization map 1130 may include a plurality of sets of keypoints in respective reference images of the set of reference images 1120 of the external environment 105, as well as a plurality of sets of reference descriptors and a plurality of sets of spatial coordinates associated with the plurality of sets of keypoints. Reference will be made to FIG. 12 below to describe an example manufacturing process of the localization map 1130.

It is worth noting that, in some embodiments, the localization map 1130 may be generated and stored by the computing device 120 of the vehicle 110 based on various data captured by the capturing vehicle 1110, so as to visually locate the vehicle 110 based on the captured image 130. In other embodiments, the localization map 1130 may be generated and stored by a computing device other than the computing device 120, or may be stored in another device. In this event, the computing device 120 may obtain the localization map 1130 from the device storing the localization map 1130 for visually locating the vehicle 110 based on the captured image 130.

FIG. 12 illustrates an example modularized operation process 1200 for generating the localization map 1130 according to embodiments of the present disclosure. For ease of description, reference will be made to FIGS. 4 and 5 below to describe the example operation process 1200 using an example in which the computing device 120 generates the localization map 1130. As shown in FIG. 12, the computing device 120 may input the set of reference images 1120 into the feature extraction model 310 to obtain a set of reference descriptor maps 1210. For example, the computing device 120 may input respective reference images in the set of reference images 1120 one by one into the feature extraction model 310 to generate a plurality of reference descriptor maps corresponding to the respective reference images, namely the set of reference descriptor maps 1210. That is to say, the set of reference descriptor maps 1210 may include a reference descriptor map of each reference image in the set of reference images 1120. For example, referring to FIG. 4, the set of reference descriptor maps 1210 may include the reference descriptor map 410 of the reference image 140. In some embodiments, the feature extraction model 310 may have feature pyramid network architecture. In those embodiments, the reference descriptor maps in the set of reference descriptor maps 1210 may have different resolutions.

Referring back to FIG. 12, the computing device 120 may input the set of reference descriptor maps 1210 into a keypoint sampling module 1220 to extract respective sets of keypoint descriptors from the reference descriptor maps in the set of reference descriptor maps 1210, thereby obtaining a plurality of sets of keypoint descriptors 1230. More specifically, the plurality of sets of keypoint descriptors 1230 may include a set of keypoint descriptors corresponding to a set of keypoints in each reference image. For example, referring to FIG. 5, the keypoint sampling module 1220 may sample the set of reference descriptors 147 corresponding to the set of keypoints 143 from the reference descriptor map 410. In some embodiments, the keypoint sampling module 1220 may extract respective sets of keypoint descriptors from the reference descriptor maps in the set of reference descriptor maps 1210 using a same sampling approach (for example, the farthest point sampling algorithm), so as to simplify the process of generating the localization map 1130. In other embodiments, the keypoint sampling module 1220 may employ different keypoint sampling approaches according to characteristics of the reference descriptor maps, so as to extract an optimal set of keypoint descriptors for each reference descriptor map. In some embodiments, the feature extraction model 310 may have feature pyramid network architecture, and those reference descriptor maps in the set of reference descriptor maps 1210 may have different resolutions. In those embodiments, the keypoint sampling module 1220 may select different sets of keypoint descriptors for reference descriptor maps having different resolutions.

Referring back to FIG. 12, on the other hand, the point cloud 510 of the external environment 105 may also be input to the keypoint sampling module 1220, such that the keypoint sampling module 1220 can obtain a plurality of sets of keypoint spatial coordinates 1240 corresponding to the plurality sets of keypoint descriptors 1230 by projection, three-dimensional reconstruction, or the like. To be specific, the plurality sets of keypoint spatial coordinates 1240 may include a set of spatial coordinates corresponding to a set of keypoints in each reference image. For example, referring to FIG. 5, the keypoint sampling module 1220 may sample the set of spatial coordinates 145 corresponding to the set of keypoints 143 from the point cloud 510.

Referring back to FIG. 12, the computing device 120 may store the plurality sets of keypoint descriptors 1230, the plurality of sets of keypoint spatial coordinates 1240, and the plurality of sets of keypoints corresponding to the set of reference images 1120 in association, for example, into a storage device (for example, a disk), so as to generate the localization map 1130. As an example, referring to FIG. 5, the computing device 120 may store the set of keypoints 143 of the reference image 140, the set of spatial coordinates 145 and the set of reference descriptors 147 in association into the localization map 1130.

Through the example operation process 1200, the computing device 120 or another computing device can generate the localization map 1130 associated with the external environment 105 of the vehicle 110 efficiently and in a centralized manner, such that when locating the vehicle 110 based on the captured image 130, the computing device 120 can retrieve related data and information for locating the vehicle 110 using the localization map 1130 as an input. As such, the computing loads and overhead of the computing device 120 for locating the vehicle 110 may be reduced greatly, and the computing device 120 may spend significantly less time on locating the vehicle 110. In addition, since the example operation process 1200 generates the localization map 1130 based on the feature extraction model 310 and the keypoint sampling module 1220, the localization map 1130 can be optimized by optimizing the feature extraction model 310 and the keypoint sampling module 1220 to improve the localization accuracy of the vehicle 110.

### Example Process of Determining Plurality of Sets of Image Descriptors

As mentioned in the description with reference to FIG. 7, in some embodiments, the projection point 710 of the first spatial coordinate 145-1 projected onto the captured image 130 may not directly correspond to a certain image point in the captured image 130, but falls among a plurality of image points in the captured image 130. In those embodiments, the computing device 120 may determine the image descriptor 715 corresponding to the projection point 710 based on a plurality of descriptors corresponding to the plurality of image points around the projection point 710. Reference will be made to FIG. 13 below to describe such an example in detail.

FIG. 13 illustrates a flowchart of an example process 1300 for determining the plurality of sets of image descriptors 165 according to embodiments of the present disclosure. In some embodiments, the example process 1300 may be implemented by the computer device 120 of the vehicle 110 in the example environment 100, for example, by a processor or processing unit of the computing device 120, or by various functional modules of the computing device 120. In other embodiments, the example process 1300 may be implemented by a computing device independent of the example environment 100, or another unit or module in the example environment 100. For ease of illustration, reference will be made to FIGS. 6 and 7 below to describe the example process 1300.

At block 1310, the computing device 120 may assume that the vehicle 110 is in the first candidate pose 155-1 among the plurality of candidate poses 155. Based on the first candidate pose 155-1, the computing device 120 may project the set of spatial coordinates 145 onto the captured image 130 such that the computing device 120 can determine a set of projection points of the set of the spatial coordinates 145, namely respective projection points corresponding to the spatial coordinates in the set of spatial coordinates 145, respectively. For example, referring to FIG. 7, assuming that the vehicle 110 is in the first candidate pose 155-1, the computing device 120 may project the first spatial coordinate 145-1 of the set of spatial coordinates 145 onto the captured image 130 to determine the projection point 710 in the captured image 130. In a similar way, the computing device 120 can project other spatial coordinates of the set of spatial coordinates 145 onto the captured image 130 to gain a set of projection points of the set of the spatial coordinates 145.

Referring back to FIG. 13, at block 1320, for a projection point of the set of projection points, the computing device 120 may determine a plurality of points neighboring the projection point in the captured image 130. For example, referring to FIG. 7, the projection point 710 may not correspond exactly to an image point (for example, a pixel) in the captured image 130 in some circumstances, and thus the corresponding descriptor 715 cannot be found directly in the image descriptor map 160. In this case, the computing device 120 may alternatively determine a plurality of image points neighboring the projection point 710 in the captured image 130, for example, two or more image points closest to the projection point 710. In other embodiments, the plurality of points neighboring the projection point 710 determined by the computing device 120 are not necessarily multiple image points closest to the projection point 710, as long as distances from those points to the projection point 710 are less than a predetermined threshold.

Referring back to FIG. 13, at block 1330, for the plurality of points neighboring the projection point, the computing device 120 may determine a plurality of descriptors of the plurality of points in the image descriptor map 160. For example, referring to FIG. 7, if the computing device 120 determines two image points closest to the projection point 710 in the captured image 130, the computing device 120 may determine two descriptors of the two image points in the image descriptor map 160. As another example, if the computing device 120 determines three or more image points neighboring the projection point 710, the computing device 120 may determine descriptors of those image points in the image descriptor map 160.

Referring back to FIG. 13, at block 1340, based on the plurality descriptors of the plurality of points neighboring the projection point, the computing device 120 may determine a descriptor of the projection point. For example, referring to FIG. 7, based on the plurality of descriptors of the plurality of image points neighboring the projection point 710, the computing device 120 may determine the descriptor 715 of the projection point 710. In an exemplary manner, the computing device 120 may use a bilinear interpolation algorithm to compute the descriptor 715 from the plurality of descriptors. It should be appreciated that the computing device 120 may obtain the descriptor 715 using any other appropriate algorithm. For example, the computing device 120 may directly compute a mean value of the plurality of descriptors as the descriptor 715, and so on. After determining the descriptor 715 of the projection point 710, the computing device 120 obtains the first image descriptor 715 in the set of image descriptors 165-1 among the plurality of sets of image descriptors 165 corresponding to the first candidate pose 155-1. Likewise, the computing device 120 may determine the plurality of sets of image descriptors 165 corresponding to the plurality of candidate poses 155, respectively.

Through the example process 1300, even though there is no descriptor in the image descriptor map 160 directly corresponding to the projection point 710 of the spatial coordinate 145-1 in the captured image 130, the computing device 120 may reasonably determine the descriptor 715 for the projection point 710. The computing device 120 may in turn reasonably determine the set of image descriptors 165-1 corresponding to the first candidate pose 155-1. Further, the computing device 120 may reasonably determine the plurality of sets of image descriptors 165 corresponding to the plurality of candidate poses 155. In this way, the ultimate accuracy of the pose of the vehicle 110 determined based on the plurality of candidate poses 155 can be improved.

### Example Pose Updating Model

As mentioned in the description with reference to FIG. 8, in some embodiments, by inputting the set of reference descriptors 147, the image descriptor map 160, the set of spatial coordinates 145 and the predicted pose 150 into the pose updating model 810, the computing device 120 may determine a plurality of similarities between the plurality of sets of image descriptors 165 and the set of reference descriptors 147, and obtain the updated predicted pose 180 at an output of the pose updating model 810. Reference will be made to FIG. 14 below to describe such an example. It should be appreciated that the specific structure of the pose updating model 810 as depicted in FIG. 14 is merely an example, without suggesting any limitation to the scope of the present disclosure. In other embodiments, the pose updating model 810 in embodiments of the present disclosure may utilize any other neural network structure.

FIG. 14 illustrates an example structure of the pose updating model 810 according to embodiments of the present disclosure. As shown in FIG. 14, the computing device 120 may supply the set of spatial coordinates 145, the predicted pose 150 and the image descriptor map 160 to a projection unit 1402 of the pose updating model 810. In the projection manner as described with reference to FIG. 7 or 13, the projection unit 1402 may compute and output the plurality of sets of image descriptors 165 corresponding to the plurality of candidate poses 155, respectively. Subsequently, for respective keypoints in the set of keypoints 143 of the reference image 140 (namely, respective spatial coordinates in the set of spatial coordinates 145), a similarity computing unit 1406 may compute a plurality of similarities between an image descriptor corresponding to a certain keypoint and a reference descriptor when the vehicle 110 is in the candidate poses 155, respectively, so as to form a similarity cube corresponding to the keypoint. Likewise, for a plurality of keypoints in the set of keypoints 143, the similarity computing unit 1406 can obtain corresponding similarity cubes 1408. As used herein, the plurality of similarity cubes 1408 may also be referred to a plurality of cost volumes.

For example, referring to FIGS. 5 to 7, for the first keypoint 143-1 (namely, the spatial coordinate 145-1), the similarity computing unit 1406 may compute a similarity between the image descriptor 715 and the reference descriptor 147-1 when the vehicle 110 is in the first candidate pose 155-1. For the first keypoint 143-1, the similarity computing unit 1406 may obtain a plurality of similarities for the plurality of candidate poses 155 in a similar manner. The plurality of similarities related to the first keypoint 143-1 may be recorded in a similarity cube 1408-1 of the plurality of similarity cubes 1408 corresponding to the first keypoint 143-1. In other words, each cost volume in the plurality of cost volumes 1408 may correspond to a keypoint of the set of keypoints 143, and the number of the plurality of cost volumes 1408 therefore may be identical to the number of keypoints in the set of keypoints 143. In the cost volume 1408-1 corresponding to the first keypoint 143-1, the way of representation of the plurality of candidate poses 155 may be identical to that as depicted in FIG. 6. That is, the predicted pose 150 may be represented by a small cube (not shown in FIG. 14) in the center of the cost volume 1408-1, while the plurality of candidate poses 155 may be denoted by small cubes (not shown in FIG. 14) distributed around the predicted pose 150. In addition, each small cube in the cost volume 1408-1 may record a similarity between the image descriptor 715 of the first keypoint 143-1 in the image descriptor map 160 and the reference descriptor 147-1 of the first keypoint 143-1 in the reference descriptor map 410 when the vehicle 110 is in a corresponding candidate pose.

Then, the plurality of cost volumes 1408 may be input into a trained Three-Dimensional Convolutional Neural Network (3D CNN) 1410 for regularization, thereby obtaining a plurality of regularized cost volumes 1412. For example, after the cost volume 1408-1 is processed by the 3D CNN 1410, a regularized cost volume 1412-1 can be obtained. In some embodiments, the 3D CNN 1410 may include three convolutional layers 1410-1, 1410-2 and 1410-3. The convolutional layers 1410-1 and 1410-2 may each have 8 channels, 1 kernel and a stride size of 1, while the convolutional layer 1410-3 may have 1 channel, 1 kernel and a stride size of 1. It should be appreciated that the specific numerical values related to the 3D CNN 1410 described herein are merely an example, without suggesting any limitation to the scope of the present disclosure. In other embodiments, the 3D CNN 1410 may be of any appropriate structure.

Next, the computing device 120 may input the plurality of regularized cost volumes 1412 into a first dimension reduction and summation unit 1414 for reducing dimensions (also referred to as marginalization) in the keypoint dimension, so as to obtain a similarity cube 1416. For example, the first dimension reduction and summation unit 1414 may add data recorded in corresponding small cubes in the plurality of regularized cost volumes 1412 to obtain the similarity cube 1416. It is to be appreciated that directly summing up the plurality of regularized cost volumes 1412 is only an example, and the first dimension reduction and summation unit 1414 may obtain the similarity cube 1416 in any other appropriate manner. For example, the first dimension reduction and summation unit 1414 may perform averaging, weighted summing, weighted averaging, or the like, on the data recorded in corresponding small cubes in the plurality of regularized cost volumes 1412. In some embodiments, the first dimension reduction and summation unit 1414 may be implemented using the “reduce_sum” function in the deep learning system “TensorFlow.” In other embodiments, the first dimension reduction and summation unit 1414 may be implemented using other similar functions in the TensorFlow system or other deep learning system.

The way of representation of the plurality candidate poses 155 in the similarity cube 1416 may be identical to that as depicted in FIG. 6, namely, the predicted pose 150 may be represented by a small cube (not shown in FIG. 14) in the center of the similarity cube 1416, while the plurality of candidate poses 155 may be represented by small cubes (not shown in FIG. 14) distributed around the predicted pose 150. In addition, each small cube in the similarity cube 1416 stores a similarity between the set of image descriptors 165-1 of the set of keypoints 143 in the image descriptor map 160 and the set of reference descriptors 147 of the set of keypoints 143 in the reference descriptor map 410 when the vehicle 110 is in a corresponding candidate pose. For example, referring to FIG. 1, the small cube in the similarity cube 1416 corresponding to the first candidate pose 155-1 stores the similarity 170-1 between the set of image descriptors 165-1 and the set of reference descriptors 147 when the vehicle 110 is in the first candidate pose 155-1.

Thereafter, the computing device 120 may input the similarity cube 1416 into a normalization unit 1418 for normalization, so as to obtain a probability distribution cube 1420. In some embodiments, the normalization unit 1418 may be implemented using the “softmax” function in the deep learning system “TensorFlow.” In other embodiments, the normalization unit 1418 may be implemented using other similar functions in the TensorFlow system or other deep learning system. The way of representation of the plurality of candidate poses 155 in the probability distribution cube 1420 may be identical to that as depicted in FIG. 6. That is, the predicted pose 150 may be represented by a small cube (not shown in FIG. 14) in the center of the probability distribution cube 1420, while the plurality of candidate poses 155 may be represented by small cubes (not shown in FIG. 14) distributed around the predicted pose 150. Moreover, each cube in the probability distribution cube 1420 stores a probability that a corresponding candidate pose is the real pose of the vehicle 110. For example, the small cube in the probability distribution cube 1420 corresponding to the first candidate pose 155-1 stores a probability that the first candidate pose 155-1 is the real pose of the vehicle 110.

The computing device 120 may then input the probability distribution cube 1420 into a second dimension reduction and summation unit 1422 to obtain the updated predicted pose 180. For example, the second dimension reduction and summation unit 1422 may compute, based on the plurality of candidate poses 155 and a plurality of probabilities corresponding thereto, an expected pose of the vehicle 110 as the updated predicted pose 180. It is to be appreciated that directly computing an expected pose based on the probabilities of the plurality of candidate poses 155 is only an example, and the second dimension reduction and summation unit 1422 may obtain the updated predicted pose 180 in other appropriate manners. For example, the probabilities of the plurality of candidate poses 155 can be weighted and then an expected pose can be computed by the second dimension reduction and summation unit 1422. In some embodiments, the second dimension reduction and summation unit 1422 may be implemented using the “reduce_sum” function in the deep learning system “TensorFlow.” In other embodiments, the second dimension reduction and summation unit 1422 may be implemented using other similar functions in the TensorFlow system or other deep learning system.

With the pose updating model 810 as depicted in FIG. 14, the accuracy of the updated predicted pose 180 ultimately determined by the computing device 120 can be improved. In this regard, it is worth noting that traditional visual localization solutions typically solve the pose estimation problem within a Random Sampling Consensus (RANSAC) algorithm framework given a set of 2D-3D keypoint correspondences, for example, using a PnP solver. Nonetheless, the traditional matching approaches including an outlier rejection step are non-differentiable and thus prevent themselves from feature learning through backpropagation during the training stage. In contrast, the pose updating model 810 as depicted in FIG. 14 leverages a differentiable 3D cost volume to evaluate the matching cost of respective feature descriptor pairs from a captured image and a reference image given a pose (or a pose offset), and finally boosts the accuracy of the updated predicted pose 180, thereby improving the performance of the localization system of embodiments of the present disclosure.

### Example Process of Using Feature Extraction Model and Feature Matching Model for Vehicle Localization

As mentioned in the description with reference to FIGS. 3 and 8, in some embodiments, the computing device 120 may utilize both of the feature extraction model 310 and the pose updating model 810 to build a localization system for the vehicle 110. In those embodiments, the computing device 120 may input the captured image 130 and the predicted pose 150 to the localization system to locate the vehicle 110. Reference will be made to FIG. 15 below to describe such an example. It should be appreciated that various functional modules or data units as depicted in FIG. 15 are provided as an example, without suggesting any limitation to the scope of the present disclosure. In other embodiments, the localization system for the vehicle 110, which includes the feature extraction model 310 and the pose updating model 810, may involve any other appropriate functional modules or data units.

FIG. 15 illustrates an example modularized operation process 1500 for generating the updated predicted pose 180 using the feature extraction model 310 and the pose updating model 810, according to embodiments of the present disclosure. In the following, reference will also be made to the examples in FIGS. 1-14 in which the computing device 120 generates the updated predicted pose 180 to describe the example operation process 1500, but it should be appreciated that the example operation process 1500 may be performed wholly or partly by another computing device different from the computing device 120 to generate the updated predicted pose 180. It is worth noting that before the localization system built from the feature extraction model 310 and the pose updating model 810 is applied to real-time localization of the vehicle 110, real localization data of the vehicle 110 and other related data measured in practice can be used as training data to perform an end-to-end training on the whole localization system, so as to determine various model parameters in the feature extraction model 310 and the pose updating model 810. In addition, as discussed above, the trained feature extraction model 310 may be used to generate the localization map 1130, and the generated localization map 1130 may be applied to the real-time localization of the vehicle 110.

As shown in FIG. 15, during the localization process of the vehicle 110 based on the captured image 130 and the predicted pose 150, the computing device 120 may determine, based on the predicted pose 150, the set of keypoints 143 in the reference image 140 corresponding to the captured image 130. For example, based on the predicted pose 150 of the vehicle 100 when capturing the captured image 130 of the external environment 105, the computing device 120 may determine the reference image 140 corresponding to the captured image 130 from the set of reference images 1120 of the external environment 105. In some embodiments, among all the reference images of the set of reference images 1120, the pose of the capturing vehicle 1110 when capturing the reference image 140 may be closest to the predicted pose 150 of the vehicle 110. After determining the reference image 140, the computing device 120 may determine the set of keypoints 143 from the reference image 140 in various possible manners as described above.

Subsequent to obtaining the set of keypoints 143, the computing device 120 may determine the set of spatial coordinates 145 and the set of reference descriptors 147 corresponding to the set of keypoints 143 in the localization map 1130. Thereafter, the computing device 120 may input the set of spatial coordinates 145 and the set of reference descriptors 147 into the pose updating model 810. On the other hand, the computing device 120 may input the captured image 130 into the feature extraction model 310 to gain the image descriptor map 160. Then, the computing device 120 may also input the image descriptor map 160 into the pose updating model 810. Furthermore, the computing device 120 may input the predicted pose 150 of the vehicle 110 into the pose updating model 810. Based on the set of spatial coordinates 145, the set of reference descriptors 147, the predicted pose 150 and the image descriptor map 160, the pose updating model 810 may output the updated predicted pose 180.

It can be seen that the localization system built from the feature extraction model 310 and the pose updating model 810 achieves a novel visual localization framework. In some embodiments, based on the localization system, an end-to-end Deep Neural Network (DNN) may be trained to extract machine learning-based feature descriptors, select keypoints from a localization map, perform feature matching between the selected keypoints and images captured by the vehicle 110 in real time, and infer the real pose of the vehicle 110 through a differentiable cost volume. Compared to the traditional solutions, the architecture of the localization system enables jointly training of various machine learning models or networks in the localization system by backpropagation and optimization towards the eventual goal of minimizing the absolute localization error. Furthermore, the localization system bypasses the repeatability crises in keypoint detectors in the traditional solutions in an efficient way.

In addition, by utilizing an end-to-end deep neural network to select keypoints, the localization system can find abundant features that are salient, distinctive and robust in a scene. The capability of full exploitation of these robust features enables the localization system to achieve centimeter localization accuracy, which is comparable to the latest LiDAR-based localization approaches and substantially greater than other vision-based approaches in terms of both robustness and accuracy. The strong performance makes the localization system ready to be integrated into a self-driving car, providing precise localization results using low-cost sensors. The experiment results demonstrate that the localization system can achieve competitive localization accuracy when compared to the LiDAR-based localization solutions under various challenging circumstances, leading to a potential low-cost localization solution for autonomous driving.

### Example Apparatus

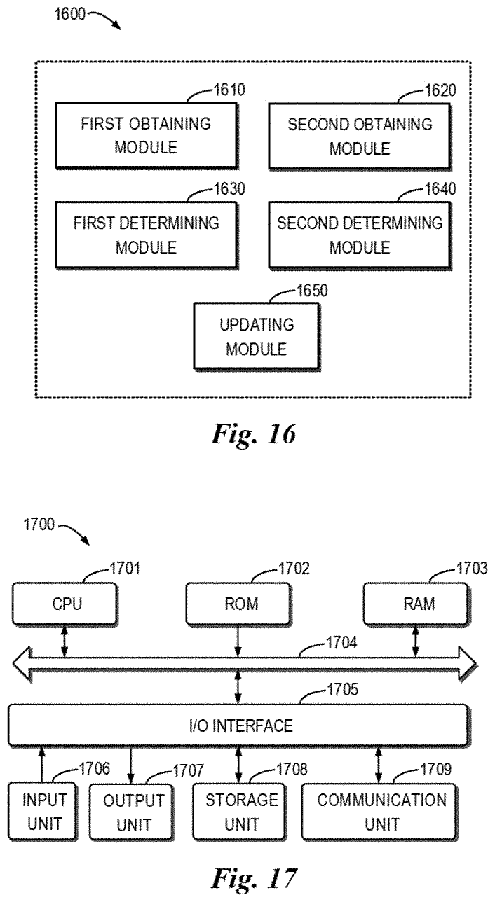

FIG. 16 illustrates a block diagram of an example apparatus 1600 for vehicle localization according to embodiments of the present disclosure. In some embodiments, the apparatus 1600 may be included in the computing device 120 in FIG. 1 or implemented as the computing device 120.

As shown in FIG. 16, the apparatus 1600 may include a first obtaining module 1610, a second obtaining module 1620, a first determining module 1630, a second determining module 1640, and an updating module 1650. The first obtaining module 1610 may be configured to obtain an image descriptor map corresponding to a captured image of an external environment of a vehicle and a predicted pose of the vehicle when the captured image is captured. The image descriptor map comprises descriptors of points in the captured image. The second obtaining module 1620 may be configured to obtain a set of reference descriptors and a set of spatial coordinates corresponding to a set of keypoints in a reference image of the external environment. The reference image is pre-captured by a capturing device.

The first determining module 1630 may be configured to determine a plurality of sets of image descriptors corresponding to the set of spatial coordinates when the vehicle is in a plurality of candidate poses, respectively. The plurality of sets of image descriptors belong to the image descriptor map. The plurality of candidate poses are obtained by offsetting the predicted pose. The second determining module 1540 may be configured to determine a plurality of similarities between the plurality of sets of image descriptors and the set of reference descriptors. The updating module 1650 may be configured to update the predicted pose based on the plurality of candidate poses and the plurality of similarities corresponding to the plurality of candidate poses.

In some embodiments, the first obtaining module 1610 may include an input module configured to input the captured image into a feature extraction model to obtain the image descriptor map. The feature extraction model is trained based on a set of training images of the external environment and a set of training descriptor maps obtained from the set of training images. The set of training descriptor maps is determined based on a difference between the updated predicted pose and a real pose of the vehicle.

In some embodiments, the second obtaining module 1620 may include: a reference image set obtaining module configured to obtain a set of reference images of the external environment, each of the set of reference images comprising a set of keypoints as well as a set of reference descriptors and a set of spatial coordinates associated with the set of keypoints, the set of spatial coordinates being determined by projecting a laser radar point cloud onto the reference image; a selection module configured to select, from the set of reference images, the reference image corresponding to the captured image based on the predicted pose; and a reference descriptor set and spatial coordinate set obtaining module configured to obtain the set of reference descriptors and the set of spatial coordinates stored in association with the set of keypoints in the reference image.

In some embodiments, the first determining module 1630 may include: a projection point set determining module configured to determine a set of projection points of the set of spatial coordinates by projecting the set of spatial coordinates onto the captured image based on a first candidate pose of the plurality of candidate poses; a neighboring point determining module configured to determine, for a projection point of the set of projection points, a plurality of points neighboring the projection point in the captured image; a descriptor determining module configured to determine a plurality of descriptors of the plurality of points in the image descriptor map; and an image descriptor obtaining module configured to determine a descriptor of the projection point based on the plurality of descriptors to obtain a first image descriptor of a set of image descriptors corresponding to the first candidate pose among the plurality of sets of image descriptors.

In some embodiments, the second determining module 1640 may include: a difference determining module configured to determine, for a first set of image descriptors among the plurality of sets of image descriptors, a plurality of differences between a plurality of image descriptors of the first set of image descriptors and corresponding reference descriptors of the set of reference descriptors; and a similarity determining module configured to determine, based on the plurality of differences, a similarity between the first set of image descriptors and the set of reference descriptors as a first similarity of the plurality of similarities.

In some embodiments, the updating module 1650 may include: a probability determining module configured to determine, based on the plurality of similarities, probabilities that the plurality of the candidate poses are the real pose, respectively; and an expected pose determining module configured to determine, based on the plurality of candidate poses and the probabilities, an expected pose of the vehicle as the updated predicted pose.

In some embodiments, the apparatus 1600 may further include a candidate pose determining module configured to determine the plurality of candidate poses by taking a horizontal coordinate, a longitudinal coordinate and a yaw angle of the predicted pose as a center and by offsetting from the center in three dimensions of a horizontal axis, a longitudinal axis and a yaw angle axis, with respective predetermined offset units and within respective predetermined maximum offset ranges.

In some embodiments, the apparatus 1600 may also include a keypoint set selection module configured to select, based on a farthest point sampling algorithm, the set of keypoints from a set of points in the reference image.

### Example Device

FIG. 17 illustrates a block diagram of an example device 1700 that can be used to implement embodiments of the present disclosure. As shown, the device 1700 includes a central processing unit (CPU) 1701 which performs various appropriate actions and processing, based on computer program instructions stored in a read-only memory (ROM) 1702 or computer program instructions loaded from a storage unit 1708 to a random access memory (RAM) 1703. The RAM 1703 stores therein various programs and data required for operations of the device 1700. The CPU 1701, the ROM 1702 and the RAM 1703 are connected via a bus 1704 with one another. An input/output (I/O) interface 1705 is also connected to the bus 1704.

The following components in the device 1700 are connected to the I/O interface 1705: an input unit 1706 such as a keyboard, a mouse and the like; an output unit 1707 including various kinds of displays and a loudspeaker, etc.; a storage unit 1708 including a magnetic disk, an optical disk, and etc.; a communication unit 1709 including a network card, a modem, and a wireless communication transceiver, etc. The communication unit 1709 allows the device 1700 to exchange information/data with other devices through a computer network such as the Internet and/or various kinds of telecommunications networks.

Various processes and processing described above, for example, the example process 200, 1000 or 1300, may be executed by the processing unit 1701. For example, in some embodiments, the example process 200, 1000 or 1300 may be implemented as a computer software program that is tangibly included in a machine readable medium, for example, the storage unit 1708. In some embodiments, part or all of the computer programs may be loaded and/or mounted onto the device 1700 via ROM 1702 and/or communication unit 1709. When the computer program is loaded to the RAM 1703 and executed by the CPU 1701, one or more steps of the example process 200, 1000 or 1300 as described above may be executed.

### Others

As used herein, the term “includes” and its variants are to be read as open terms that mean “includes, but is not limited to.” The term “based on” is to be read as “based at least in part on.” The term “one embodiment” and “the embodiment” are to be read as “at least one embodiment.” The terms “first,” “second,” and the like may refer to different or same objects. Other definitions, explicit and implicit, may be included in the context.

As used herein, the term “determining” covers various acts. For example, “determining” may include operation, calculation, processing, derivation, investigation, search (for example, search through a table, a database or a further data structure), identification and the like. In addition, “determining” may include receiving (for example, receiving information), accessing (for example, accessing data in the memory) and the like. Further, “determining” may include resolving, selecting, choosing, establishing and the like.

It will be noted that the embodiments of the present disclosure can be implemented in software, hardware, or a combination thereof. The hardware part can be implemented by a special logic; the software part can be stored in a memory and executed by a suitable instruction execution system such as a microprocessor or special purpose hardware. Those skilled in the art should appreciate that the above apparatus and method may be implemented with computer executable instructions and/or in processor-controlled code, and for example, such code is provided on a carrier medium such as a programmable memory or an optical or electronic signal bearer.

Further, although operations of the present methods are described in a particular order in the drawings, it does not require or imply that these operations are necessarily performed according to this particular sequence, or a desired outcome can only be achieved by performing all shown operations. On the contrary, the execution order for the steps as depicted in the flowcharts may be varied. Alternatively, or in addition, some steps may be omitted, a plurality of steps may be merged into one step, or a step may be divided into a plurality of steps for execution. It should be appreciated that features and functions of two or more devices according to the present disclosure can be implemented in combination in a single device. Conversely, various features and functions that are described in the context of a single device may also be implemented in multiple devices.

Although the present disclosure has been described with reference to various embodiments, it should be understood that the present disclosure is not limited to the disclosed embodiments. The present disclosure is intended to cover various modifications and equivalent arrangements included in the spirit and scope of the appended claims.

The various embodiments described above can be combined to provide further embodiments. Aspects of the embodiments can be modified to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for vehicle localization, comprising:
obtaining an image descriptor map corresponding to a captured image of an external environment of a vehicle and a predicted pose of the vehicle when the captured image is captured, the image descriptor map comprising descriptors of points in the captured image;
obtaining a set of reference descriptors and a set of spatial coordinates corresponding to a set of keypoints in a reference image of the external environment, the reference image being pre-captured by a capturing device;
determining a plurality of sets of image descriptors corresponding to the set of spatial coordinates when the vehicle is in a plurality of candidate poses, respectively, the plurality of sets of image descriptors belonging to the image descriptor map, the plurality of candidate poses being obtained by offsetting the predicted pose;
determining a plurality of similarities between the plurality of sets of image descriptors and the set of reference descriptors; and
updating the predicted pose based on the plurality of candidate poses and the plurality of similarities corresponding to the plurality of candidate poses.

2. The method of claim 1, wherein obtaining the image descriptor map comprises:
inputting the captured image into a feature extraction model to obtain the image descriptor map, the feature extraction model being trained based on a set of training images of the external environment and a set of training descriptor maps obtained from the set of training images, the set of training descriptor maps being determined based on a difference between the updated predicted pose and a real pose of the vehicle.

3. The method of claim 1, wherein obtaining the set of reference descriptors and the set of spatial coordinates comprises:
obtaining a set of reference images of the external environment, each of the set of reference images comprising a set of keypoints as well as a set of reference descriptors and a set of spatial coordinates associated with the set of keypoints, the set of spatial coordinates being determined by projecting a laser radar point cloud onto the reference image;
selecting, from the set of reference images, the reference image corresponding to the captured image based on the predicted pose; and
obtaining the set of reference descriptors and the set of spatial coordinates stored in association with the set of keypoints in the reference image.

4. The method of claim 1, wherein determining the plurality of image descriptors comprises:
determining a set of projection points of the set of spatial coordinates by projecting the set of spatial coordinates onto the captured image based on a first candidate pose of the plurality of candidate poses;
determining, for a projection point of the set of projection points, a plurality of points neighboring the projection point in the captured image;
determining a plurality of descriptors of the plurality of points in the image descriptor map; and
determining a descriptor of the projection point based on the plurality of descriptors to obtain a first image descriptor of a set of image descriptors corresponding to the first candidate pose among the plurality of sets of image descriptors.

5. The method of claim 1, wherein determining the plurality of similarities comprises:
determining, for a first set of image descriptors among the plurality of sets of image descriptors, a plurality of differences between a plurality of image descriptors of the first set of image descriptors and corresponding reference descriptors of the set of reference descriptors; and
determining, based on the plurality of differences, a similarity between the first set of image descriptors and the set of reference descriptors as a first similarity of the plurality of similarities.

6. The method of claim 1, wherein updating the predicted pose comprises:
determining, based on the plurality of similarities, probabilities that the plurality of the candidate poses are real poses, respectively; and
determining, based on the plurality of candidate poses and the probabilities, an expected pose of the vehicle as the updated predicted pose.

7. The method of claim 1, further comprising:
determining the plurality of candidate poses by taking a horizontal coordinate, a longitudinal coordinate and a yaw angle of the predicted pose as a center and by offsetting from the center in three dimensions of a horizontal axis, a longitudinal axis and a yaw angle axis with respective predetermined offset units and within respective predetermined maximum offset ranges.

8. The method of claim 1, further comprising:
selecting, based on a farthest point sampling algorithm, the set of keypoints from a set of points in the reference image.

9. An electronic device, comprising:
at least one processor; and
a memory communicatively connected to the at least one processor;
wherein the memory stores instructions executable by the at least one processor, the instructions when executed by the at least one processor causing the at least one processor to:
obtain an image descriptor map corresponding to a captured image of an external environment of a vehicle and a predicted pose of the vehicle when the captured image is captured, the image descriptor map comprising descriptors of points in the captured image;
obtain a set of reference descriptors and a set of spatial coordinates corresponding to a set of keypoints in a reference image of the external environment, the reference image being pre-captured by a capturing device;
determine a plurality of sets of image descriptors corresponding to the set of spatial coordinates when the vehicle is in a plurality of candidate poses, respectively, the plurality of sets of image descriptors belonging to the image descriptor map, the plurality of candidate poses being obtained by offsetting the predicted pose;
determine a plurality of similarities between the plurality of sets of image descriptors and the set of reference descriptors; and
update the predicted pose based on the plurality of candidate poses and the plurality of similarities corresponding to the plurality of candidate poses.

10. The electronic device of claim 9, wherein the instructions when executed by the at least one processor cause the at least one processor to obtain the image descriptor map by:
inputting the captured image into a feature extraction model to obtain the image descriptor map, the feature extraction model being trained based on a set of training images of the external environment and a set of training descriptor maps obtained from the set of training images, the set of training descriptor maps being determined based on a difference between the updated predicted pose and a real pose of the vehicle.

11. The electronic device of claim 9, wherein the instructions when executed by the at least one processor cause the at least one processor to obtain the set of reference descriptors and the set of spatial coordinates by:
obtaining a set of reference images of the external environment, each of the set of reference images comprising a set of keypoints as well as a set of reference descriptors and a set of spatial coordinates associated with the set of keypoints, the set of spatial coordinates being determined by projecting a laser radar point cloud onto the reference image;
selecting, from the set of reference images, the reference image corresponding to the captured image based on the predicted pose; and
obtaining the set of reference descriptors and the set of spatial coordinates stored in association with the set of keypoints in the reference image.

12. The electronic device of claim 9, wherein the instructions when executed by the at least one processor cause the at least one processor to determine the plurality of image descriptors by:
determining a set of projection points of the set of spatial coordinates by projecting the set of spatial coordinates onto the captured image based on a first candidate pose of the plurality of candidate poses;
determining, for a projection point of the set of projection points, a plurality of points neighboring the projection point in the captured image;
determining a plurality of descriptors of the plurality of points in the image descriptor map; and
determining a descriptor of the projection point based on the plurality of descriptors to obtain a first image descriptor of a set of image descriptors corresponding to the first candidate pose among the plurality of sets of image descriptors.

13. The electronic device of claim 9, wherein the instructions when executed by the at least one processor cause the at least one processor to determine the plurality of similarities by:
determining, for a first set of image descriptors among the plurality of sets of image descriptors, a plurality of differences between a plurality of image descriptors of the first set of image descriptors and corresponding reference descriptors of the set of reference descriptors; and
determining, based on the plurality of differences, a similarity between the first set of image descriptors and the set of reference descriptors as a first similarity of the plurality of similarities.

14. The electronic device of claim 9, wherein the instructions when executed by the at least one processor cause the at least one processor to update the predicted pose by:
determining, based on the plurality of similarities, probabilities that the plurality of the candidate poses are the real pose, respectively; and
determining, based on the plurality of candidate poses and the probabilities, an expected pose of the vehicle as the updated predicted pose.

15. The electronic device of claim 9, wherein the instructions when executed by the at least one processor cause the at least one processor further to:
determine the plurality of candidate poses by taking a horizontal coordinate, a longitudinal coordinate and a yaw angle of the predicted pose as a center and by offsetting from the center in three dimensions of a horizontal axis, a longitudinal axis and a yaw angle axis with respective predetermined offset units and within respective predetermined maximum offset ranges.

16. The electronic device of claim 9, wherein the instructions when executed by the at least one processor cause the at least one processor further to:
select, based on a farthest point sampling algorithm, the set of keypoints from a set of points in the reference image.

17. A non-transitory computer readable storage medium storing computer instructions, the computer instructions causing a computer to:
obtain an image descriptor map corresponding to a captured image of an external environment of a vehicle and a predicted pose of the vehicle when the captured image is captured, the image descriptor map comprising descriptors of points in the captured image;
obtain an image descriptor map corresponding to a captured image of an external environment of a vehicle and a predicted pose of the vehicle when the captured image is captured, the image descriptor map comprising descriptors of points in the captured image;
obtain a set of reference descriptors and a set of spatial coordinates corresponding to a set of keypoints in a reference image of the external environment, the reference image being pre-captured by a capturing device;
determine a plurality of sets of image descriptors corresponding to the set of spatial coordinates when the vehicle is in a plurality of candidate poses, respectively, the plurality of sets of image descriptors belonging to the image descriptor map, the plurality of candidate poses being obtained by offsetting the predicted pose;
determine a plurality of similarities between the plurality of sets of image descriptors and the set of reference descriptors; and
update the predicted pose based on the plurality of candidate poses and the plurality of similarities corresponding to the plurality of candidate poses.

18. The non-transitory computer readable storage medium of claim 17, wherein the computer instructions cause the computer to obtain the image descriptor map by:
inputting the captured image into a feature extraction model to obtain the image descriptor map, the feature extraction model being trained based on a set of training images of the external environment and a set of training descriptor maps obtained from the set of training images, the set of training descriptor maps being determined based on a difference between the updated predicted pose and a real pose of the vehicle.

19. The non-transitory computer readable storage medium of claim 17, wherein the computer instructions cause the computer to obtain the set of reference descriptors and the set of spatial coordinates by:
obtaining a set of reference images of the external environment, each of the set of reference images comprising a set of keypoints as well as a set of reference descriptors and a set of spatial coordinates associated with the set of keypoints, the set of spatial coordinates being determined by projecting a laser radar point cloud onto the reference image;
selecting, from the set of reference images, the reference image corresponding to the captured image based on the predicted pose; and
obtaining the set of reference descriptors and the set of spatial coordinates stored in association with the set of keypoints in the reference image.

20. The non-transitory computer readable storage medium of claim 17, wherein the computer instructions cause the computer to determine the plurality of image descriptors by:
determining a set of projection points of the set of spatial coordinates by projecting the set of spatial coordinates onto the captured image based on a first candidate pose of the plurality of candidate poses;
determining, for a projection point of the set of projection points, a plurality of points neighboring the projection point in the captured image;
determining a plurality of descriptors of the plurality of points in the image descriptor map; and
determining a descriptor of the projection point based on the plurality of descriptors to obtain a first image descriptor of a set of image descriptors corresponding to the first candidate pose among the plurality of sets of image descriptors.
